(19) United States
(12) Patent Application Publication
(10) Pub. No.: US 2021/0389570 A1
(43) Pub. Date: Dec. 16, 2021

(54) Optical Imaging Lens

(71) Applicant: ZHEJIANG SUNNY OPTICS CO.,LTD., Ningbo, Zhejiang (CN)

(72) Inventors: Xinquan WANG, Ningbo, Zhejiang (CN); Qiqi LOU, Ningbo, Zhejiang (CN); Fujian DAI, Ningbo, Zhejiang (CN); Liefeng ZHAO, Ningbo, Zhejiang (CN)

(21) Appl. No.: 17/059,485

(22) PCT Filed: Sep. 27, 2019
(86) PCT No.: PCT/CN2019/108452

§ 371 Date: Nov. 30, 2020

(30) Foreign Application Priority Data
Mar. 5, 2019 (CN) 201910164520.9

(51) Int. Cl. G02B 13/00; G02B 9/60; G02B 27/00

(52) U.S. Cl. CPC G02B 13/0045; G02B 27/0025; G02B 9/60

(57) ABSTRACT

The disclosure discloses an optical imaging lens, sequentially comprising from an object side to an image side along an optical axis: a first lens, a second lens, a third lens, a fourth lens and a fifth lens having refractive power. The first lens has a positive refractive power, an object-side surface thereof is a convex surface; the second lens has a negative refractive power; TTL is a distance from an object-side surface of the first lens to an imaging surface of the optical imaging lens on the optical axis and a total effective focal length f of the optical imaging lens meet TTL/f<0.9; and an abbe number V3 of the third lens and an abbe number V4 of the fourth lens meet 0<V3−V4<10.

### CROSS-REFERENCE TO RELATED APPLICATION(S)

The present application claims priority to and the benefit of Chinese Patent Application No. 201910164520.9, filed in the China National Intellectual Property Administration (CNIPA) on 5 Mar. 2019, which is incorporated herein by reference in its entirety.

### TECHNICAL FIELD

The disclosure relates to an optical imaging lens, and more particularly, to an optical imaging lens including five lenses.

### BACKGROUND

With the ultra-thin trend of mobile phones, tablet computers and other portable electronic products, imaging lenses mounted thereon need to be smaller and smaller. In order to realize miniaturization, it is necessary to reduce the number of lenses of the imaging lens as much as possible, but the resulting lack of freedom in design may make it difficult to meet the market demand for high imaging performance.

According to the current double-camera shooting technology, high spatial angular resolution can be obtained through the telephoto lens, and then high-frequency information enhancement is realized through the image fusion technology. Therefore, it is significant to design the telephoto lens of the double cameras. In particular, it is more difficult to design both telephoto and ultra-thin telephoto lenses

### SUMMARY

Some embodiments of the disclosure provide an optical imaging lens which may be applied to portable electronic products, and may at least solve or partially solve at least one of the above shortcomings in a related art, for example, telephoto lens.

The disclosure provides such an optical imaging lens, which can sequentially comprise from an object side to an image side along an optical axis: a first lens with positive refractive power, an object-side surface thereof may be a convex surface; a second lens with negative refractive power; a third lens with refractive power; a fourth lens with refractive power; and a fifth lens with refractive power.

In an implementation mode, TTL is a distance from an object-side surface of the first lens to an imaging surface of the optical imaging lens on an optical axis and a total effective focal length f of the optical imaging lens may meet TTL/f<0.9.

In an implementation mode, an abbe number V1 of the first lens and an abbe number V2 of the second lens may meet 40≤V1−V2<65.

In an implementation mode, an abbe number V3 of the third lens and an abbe number V4 of the fourth lens may meet 0<V3−V4<10.

In an implementation mode, a separation distance T12 of the first lens and the second lens on an optical axis and a separation distance T23 of the second lens and the third lens on an optical axis may meet 0<T23/T12<1.5.

In an implementation mode, a center thickness CT1 of the first lens, a center thickness CT4 of the fourth lens and a center thickness CT5 of the fifth lens may meet 1.0<CT1/(CT4+CT5)<2.0.

In an implementation mode, a total effective focal length f of the optical imaging lens and a center thickness CT1 of the first lens may meet 4.5<f/CT1<6.0.

In an implementation mode, a vector height SAG41 of an object-side surface of the fourth lens and a center thickness CT4 of the fourth lens may meet −1.5≤SAG41/CT4≤−0.9.

In an implementation mode, a total effective focal length f of the optical imaging lens and a distance T34 of the third lens and the fourth lens on an optical axis may meet 3.5<f/T34<5.5.

In an implementation mode, a curvature radius R6 of an image-side surface of the third lens and a curvature radius R7 of an object-side surface of the fourth lens may meet 0≤(R6+R7)/(R6−R7)≤0.6.

In an implementation mode, a total effective focal length f of the optical imaging lens, a curvature radius R3 of an object-side surface of the second lens and a curvature radius R4 of an image-side surface of the second lens may meet 3.0<f/R3+f/R4<5.5.

In an implementation mode, ImgH is a half the diagonal length of an effective pixel area on an imaging surface of the optical imaging lens, TTL is a distance from the object-side surface of the first lens to the imaging surface of the optical imaging lens on the optical axis, TTL and ImgH meet TTL/ImgH≤1.9.

In an implementation mode, a total effective focal length f of the optical imaging lens and an effective focal length f4 of the first lens may meet −0.2≤f/f4≤0.6.

In an implementation mode, a total effective focal length f of the optical imaging lens, a curvature radius R8 of an image-side surface of the fourth lens and a curvature radius R9 of an object-side surface of the fifth lens may meet −7.0<f/R8+f/R9<−4.0.

In an implementation mode, both the first lens and the second lens may be glass lenses.

According to the disclosure, five lenses are adopted, with at least one beneficial effect of being ultra-thin, high in imaging quality, long in focal length, convenient to process and manufacture and the like through reasonable matching of lenses made of different materials and reasonable distribution of the refractive power, the surface type, the center thickness of each lens, the axial distance between the lenses and the like.

### BRIEF DESCRIPTION OF THE DRAWINGS

Other features, objects, and advantages of the disclosure will become more apparent from the following detailed description of non-limiting embodiments, taken in conjunction with the accompanying drawings. In the accompanying drawings:

FIG. 1 shows a schematic structural view of an optical imaging lens according to embodiment 1 of the disclosure;

FIG. 2A to FIG. 2D show an longitudinal aberration curve, an astigmatism curve, a distortion curve and a lateral color curve of an optical imaging lens of embodiment 1, respectively;

FIG. 3 shows a schematic structural view of an optical imaging lens according to embodiment 2 of the disclosure;

FIG. 4A to FIG. 4D show an longitudinal aberration curve, an astigmatism curve, a distortion curve and a lateral color curve of an optical imaging lens of embodiment 2, respectively;

FIG. 5 shows a schematic structural view of an optical imaging lens according to embodiment 3 of the disclosure;

FIG. 6A to FIG. 6D show an longitudinal aberration curve, an astigmatism curve, a distortion curve and a lateral color curve of an optical imaging lens of embodiment 3, respectively;

FIG. 7 shows a schematic structural view of an optical imaging lens according to embodiment 4 of the disclosure;

FIG. 8A to FIG. 8D show an longitudinal aberration curve, an astigmatism curve, a distortion curve and a lateral color curve of an optical imaging lens of embodiment 4, respectively;

FIG. 9 shows a schematic structural view of an optical imaging lens according to embodiment 5 of the disclosure;

FIG. 10A to FIG. 10D show an longitudinal aberration curve, an astigmatism curve, a distortion curve and a lateral color curve of an optical imaging lens of embodiment 5, respectively;

FIG. 11 shows a schematic structural view of an optical imaging lens according to embodiment 6 of the disclosure;

FIG. 12A to FIG. 12D show an longitudinal aberration curve, an astigmatism curve, a distortion curve and a lateral color curve of an optical imaging lens of embodiment 6, respectively;

FIG. 13 shows a schematic structural view of an optical imaging lens according to embodiment 7 of the disclosure;

FIG. 14A to FIG. 14D show an longitudinal aberration curve, an astigmatism curve, a distortion curve and a lateral color curve of an optical imaging lens of Embodiment 7, respectively;

FIG. 15 shows a schematic structural view of an optical imaging lens according to Embodiment 8 of the disclosure;

FIG. 16A to FIG. 16D show an longitudinal aberration curve, an astigmatism curve, a distortion curve and a lateral color curve of an optical imaging lens of Embodiment 8, respectively;

FIG. 17 shows a schematic structural view of an optical imaging lens according to Embodiment 9 of the disclosure;

FIG. 18A to FIG. 18D show an longitudinal aberration curve, an astigmatism curve, a distortion curve and a lateral color curve of an optical imaging lens of Embodiment 9, respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third, etc. are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or an aspherical shape shown in the drawings is shown by some embodiments. That is, the spherical shape or the aspherical shape is not limited to the spherical shape or the aspherical shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if the lens surface is a concave surface and a position of the concave surface is not defined, it indicates that the lens surface is a concave surface at least in the paraxial region. A surface of each lens closest to an object-side is called an object-side surface of the lens, and a surface of each lens closest to an imaging surface is called an image-side surface of the lens.

It also should be understood that terms “include”, “including”, “have”, “contain” and/or “containing”, used in this description, represent existence of a stated feature, component and/or part but do not exclude existence or addition of one or more other features, components and parts and/or combinations thereof. In addition, expressions like “at least one in . . . ” may appear after a list of listed features not to modify an individual component in the list but to modify the listed features. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by the general technical personnel in the field of the disclosure. It also should be understood that the terms (for example, terms defined in a common dictionary) should be explained to have meanings consistent with the meanings in the context of correlation technique and cannot be explained with ideal or excessively formal meanings, unless clearly defined like this in the disclosure.

It should be noted that the embodiments in the disclosure and features in the embodiments can be combined without conflicts. The disclosure will be described below with reference to the drawings and in combination with the embodiments in detail.

The features, principles and other aspects of the disclosure will be described below in detail.

An optical imaging lens according to an exemplary embodiment of the disclosure may include five lenses having refractive power, that is, a first lens, a second lens, a third lens, a fourth lens and a fifth lens. The five lenses are sequentially arranged from an object side to an image side along an optical axis. In the first lens to the fifth lens, any two adjacent lenses may be an air space between them.

In an implementation mode, the first lens may have a positive refractive power, an object-side surface thereof may be a convex surface; the second lens may have a negative refractive power; the third lens, the fourth lens, and the fifth lens may each have positive refractive power or negative refractive power.

Optionally, both the first lens and the second lens may be glass lenses.

In an implementation mode, an object-side surface of the second lens may be a convex surface and an image-side surface may be a concave surface. At least one of an object-side surface and an image-side surface of the third lens may be a concave surface, for example, an image-side surface of the third lens may be a concave surface. An object-side of the fourth lens may be a concave surface and an image-side surface may be a convex surface. An object-side surface of the fifth lens may be a concave surface and an image-side surface may be a convex surface.

In an implementation mode, the optical imaging lens of the disclosure may meet the condition expression TTL/f<0.9, wherein TTL is a distance from an object-side surface of the first lens to an imaging surface of the optical imaging lens on an optical axis, and f is a total effective focal length of the optical imaging lens. More specifically, TTL and f may further meet 0.80≤TTL/f≤0.85. By controlling the ratio of the total length and the focal length of the system, the long-focus characteristic can be well realized.

In an implementation mode, the optical imaging lens of the disclosure may meet the condition expression 40≤V1−V2<65, wherein V1 is an abbe number of the first lens and V2 is an abbe number of the second lens. More specifically, V1 and V2 may further meet 40.61≤V1−V2≤62.71. Through reasonable matching of an abbe number of the first lens and an abbe number of the second lens, a vertical axis chromatic aberration can be well corrected, and imaging quality of the system is improved.

In an implementation mode, the optical imaging lens of the disclosure may meet the condition expression 0<V3−V4<10, wherein V3 is an abbe number of the third lens and V4 is an abbe number of the fourth lens. More specifically, V3 and V4 may further meet 4.0≤V3−V4≤4.5, e.g., V3-V4=4.24. By reasonably controlling an abbe number of the third lens and an abbe number of the fourth lens, a lateral chromatic aberration, a congitudinal chromatic aberration and a spherochromatism can be well corrected, so that a better system imaging quality is obtained.

In an implementation mode, the optical imaging lens of the disclosure may meet the condition expression 0<T23/T12<1.5, wherein T12 is a separation distance of the first lens and the second lens on an optical axis, and T23 is a separation distance of the second lens and the third lens on an optical axis. More specifically, T23 and T12 may further meet 0.11≤T23/T12≤1.48. By controlling the separation distance between the first lens, the second lens and the separation distance between the second lens and the third lens, a field curvature and a spherochromatism of the system can be well corrected, and a sensitivity of the system is reduced.

In an implementation mode, the optical imaging lens of the disclosure may meet the condition expression 1.0<CT1/(CT4+CT5)<2.0, wherein CT1 is a center thickness of the first lens (i.e., an on-optical axis thickness of the first lens) and CT4 is a center thickness of the fourth lens (i.e., an on-optical axis thickness of the fourth lens), and CT5 is a center thickness of the fifth lens (i.e., an on-optical axis thickness of the fifth lens). More specifically, CT1, CT4 and CT5 may further meet 1.14≤CT1/(CT4+CT5)≤1.83. By reasonably controlling the center thicknesses of the first lens, the fourth lens and the fifth lens, a spherical aberration and a coma near the center view can be well balanced, and a thickness sensitivity of the system is reduced.

In an implementation mode, the optical imaging lens of the disclosure may meet the condition expression 4.5<f/CT1<6.0, wherein f is a total effective focal length of the optical imaging lens and CT1 is a center thickness of the first lens. More specifically, f and CT1 may further meet 4.87≤f/CT155.85. By controlling the focal length of the system and the center thickness of the first lens, a field angle can be shared better, and a spherical aberration and a coma of the system can be reduced.

In an implementation mode, the optical imaging lens of the disclosure may meet the condition expression −1.5≤SAG41/CT4≤−0.9, wherein SAG41 is a vector height of an object-side surface of the fourth lens (i.e., SAG41 is an on-axis distance from the intersection of an object-side surface of the fourth lens and an optical axis to an effective semi-aperture apex of an object-side surface of the fourth lens), and CT4 is a center thickness of the fourth lens. More specifically, SAG41 and CT4 may further meet −1.42≤SAG41/CT4≤−0.96. By controlling the vector height of an object-side surface of the fourth lens, off-axis aberrations such as field curvature, astigmatism, distortion and the like is better balanced.

In an implementation mode, the optical imaging lens of the disclosure may meet the condition expression 3.5<f/T34<5.5, wherein f is a total effective focal length of the optical imaging lens and T34 is a separation distance of the third lens and the fourth lens on an optical axis. More specifically, f and T34 may further meet 3.71≤f/T34≤5.06. By controlling the focal length and the air space of the third lens and the fourth lens, a refractive power and an aberration of the front lens group and a rear lens group can be well balanced, and the optical lens has good process ability.

In an implementation mode, the optical imaging lens of the disclosure may meet the condition expression 0≤(R6+R7)/(R6-R7)≤0.6, wherein R6 is a curvature radius of an image-side surface of the third lens and R7 is a curvature radius of an object-side surface of the fourth lens. More specifically, R6 and R7 may further meet 0.04≤(R6+R7)/(R6−R7)≤0.59. By reasonably distributing radii of curvature of an image-side surface of the third lens and an object-side surface of the fourth lens, a refractive power of the system can be well balanced, and meanwhile an eccentric sensitivity of the system can be reduced.

In an implementation mode, the optical imaging lens of the disclosure may meet the condition expression 3.0<f/R3+f/R4<5.5, wherein f is a total effective focal length of the optical imaging lens, R3 is a curvature radius of an object-side surface of the second lens, and R4 is a curvature radius of an image-side surface of the second lens. More specifically, f, R3 and R4 may further meet 3.46≤f/R3+f/R4≤5.23. By reasonably distributing radii of curvature of an object-side surface and an image-side surface of the second lens, a refractive power of the system can be well balanced, a tolerance sensitivity is reduced, and an imaging performance is improved.

In an implementation mode, the optical imaging lens of the disclosure may meet the condition expression TTL/ImgH≤1.9, wherein TTL is a distance from an object-side surface of the first lens to an imaging surface of the optical imaging lens on an optical axis, and ImgH is a half the diagonal length of an effective pixel area on an imaging surface of the optical imaging lens. More specifically, TTL and ImgH may further meet 1.82≤TTL/ImgH≤1.90. By controlling the overall length and the image surface size of the system, an ultra-thin requirement is met.

In an implementation mode, the optical imaging lens of the disclosure may meet the condition expression −0.25≤f/f4≤0.6, wherein f is a total effective focal length of the optical imaging lens and f4 is a effective focal length of the fourth lens. More specifically, f and f4 may further meet −0.185f/f4≤0.58. By controlling the focal length of the fourth lens, a refractive power of the front group system is well balanced, so that the system meets the long-focus characteristic.

In an implementation mode, the optical imaging lens of the disclosure may meet the condition expression −7.0<f/R8+f/R9<−4.0, wherein f is a total effective focal length of the optical imaging lens, R8 is a curvature radius of an image-side surface of the fourth lens, and R9 is a curvature radius of an object-side surface of the fifth lens. More specifically, f, R8 and R9 may further meet −6.66≤f/R8+f/R9≤−4.24. By controlling the curvature radius of an object-side surface and an image-side surface of the fourth lens, the paraxial aberrations such as spherical aberration, coma and the like of the front group system can be effectively corrected.

In an implementation mode, the above optical imaging lens may further include at least a diaphragm. The diaphragm may be positioned as desired, for example, between the first lens and the second lens, between the second lens and the third lens, or between the third lens and the fourth lens. Optionally, the optical imaging lens may further include an optical filter configured to correct the chromatic aberration and/or a protective glass for protecting a photosensitive element located on the imaging surface.

The optical imaging lens according to the above-described embodiment of the disclosure may employ a plurality of lenses, e.g. five lenses as above. By reasonably distributing refractive power, surface type and center thickness of each lens and the axial distance between the lenses and the like, the size of the imaging lens can be effectively reduced, the sensitivity of the imaging lens is reduced, the process ability of the imaging lens is improved, the optical imaging lens is more beneficial to production and processing, and the optical imaging lens is applicable to portable electronic products. The disclosure provides a solution of a five-piece lens, which enables the lens to simultaneously consider being long focus, ultra-thin and high resolution by matching and designing different materials, and obtains better imaging quality.

In an embodiment of the disclosure, at least one of the mirror surfaces of each lens is an aspheric mirror surface, that is, at least one of an object-side surface and an image-side surface of each of the first lens, the second lens, the third lens, the fourth lens, and the fifth lens is an aspheric mirror surface. The aspherical lens has the features that the curvature varies continuously from the center of the lens to the periphery of the lens. Unlike a spherical lens having a constant curvature from the center of the lens to the periphery of the lens, an aspherical lens has better curvature radius characteristics, and has the advantages of improving distortion and improving astigmatic aberration. By adopting the aspheric lens, the aberration occurring during imaging can be eliminated as much as possible, thereby improving the imaging quality. Optionally, an object-side surface and an image-side of each of the first lens, the second lens, the third lens, the fourth lens, and the fifth lens are aspheric mirrors.

However, those skilled in the art should know that the number of the lenses forming the optical imaging lens may be changed without departing from the technical solutions claimed in the disclosure to achieve each result and advantage described in the description. For example, although descriptions are made in the implementation mode with five lenses as an example, the optical imaging lens is not limited to five lenses. If necessary, the optical imaging lens may further include another number of lenses.

Specific embodiments of the optical imaging lens applicable to the above-described embodiments are further described below with reference to the accompanying drawings.

### Embodiment 1

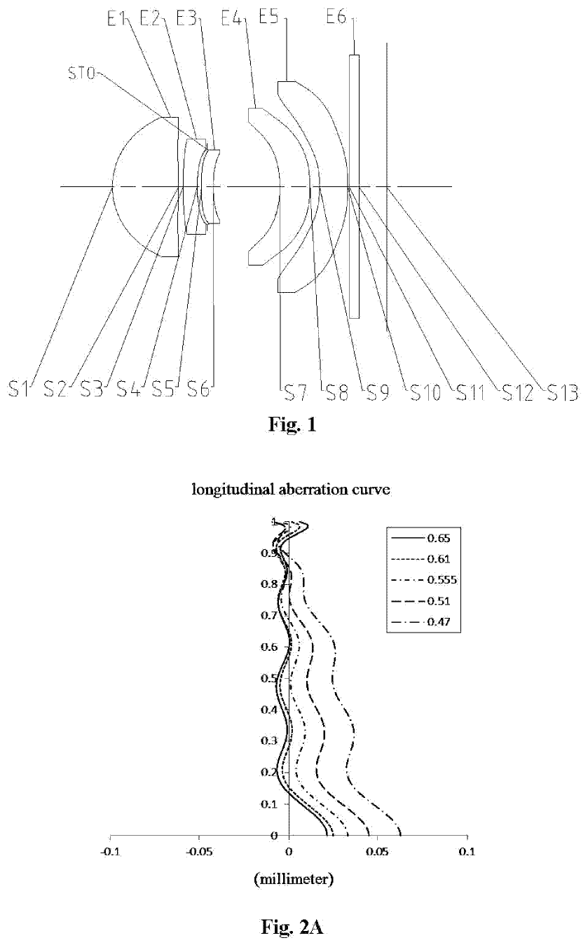

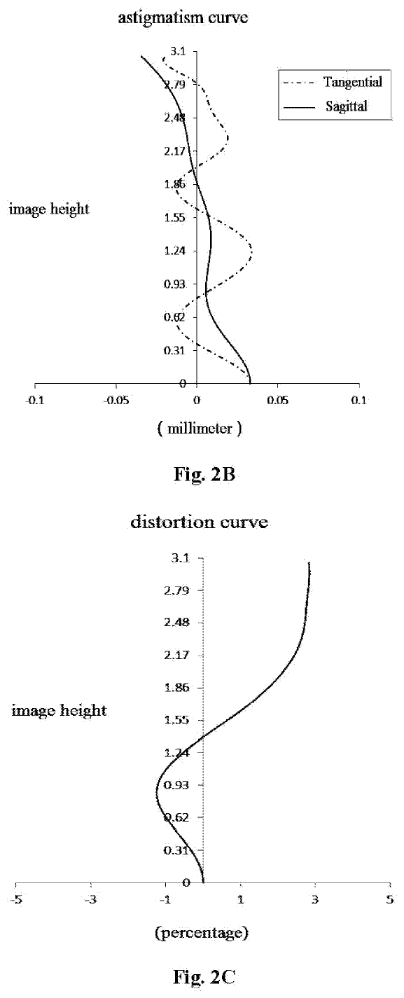

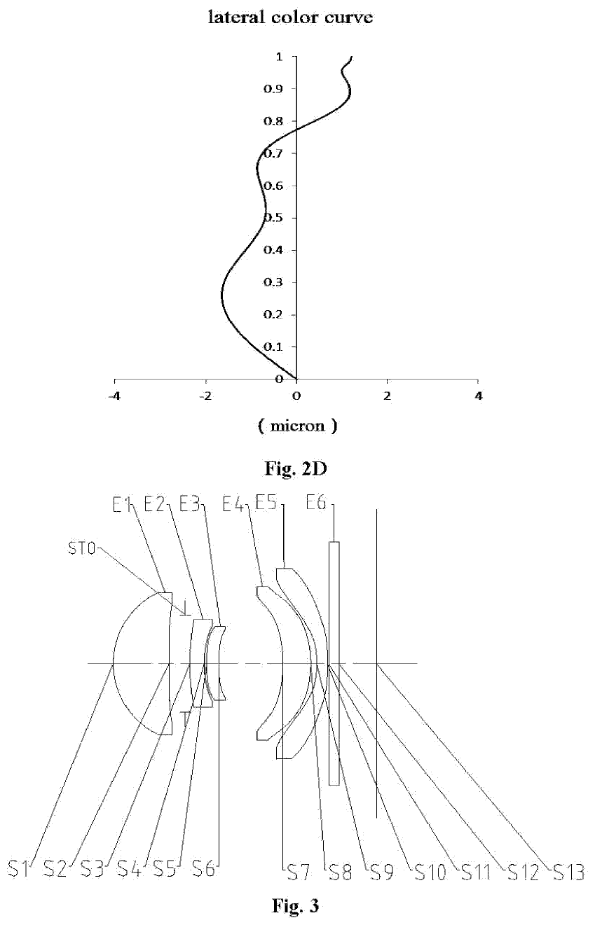

An optical imaging lens according to embodiment 1 of the disclosure is described below with reference to FIG. 1 to FIG. 2D. FIG. 1 shows a schematic structural view of an optical imaging lens according to embodiment 1 of the disclosure.

As shown in FIG. 1, an optical imaging lens includes sequentially from an object side to an image side along an optical axis: a first lens E1, a second lens E2, a diaphragm STO, a third lens E3, a fourth lens E4, a fifth lens E5, an optical filter E6 and an imaging surface S13.

The first lens E1 has a positive refractive power, an object-side surface S1 thereof is a convex surface, and an image-side surface S2 is a convex surface. The second lens E2 has a negative refractive power, an object-side surface S3 thereof is a convex surface, and an image-side surface S4 is a concave surface. The third lens E3 has a negative refractive power, an object-side surface S5 thereof is a convex surface, and an image-side surface S6 is a concave surface. The fourth lens E4 has a negative refractive power, an object-side surface S7 thereof is a concave surface, and an image-side surface S8 is a convex surface. The fifth lens E5 has a negative refractive power, an object-side surface S9 thereof is a concave surface, and an image-side surface S10 is a convex surface. The optical filter E6 has an object-side surface S11 and an image-side surface S12. Light from an object sequentially penetrates through each of the surfaces S1 to S12 and is finally imaged on the imaging surface S13.

Table 1 shows basic parameters of the optical imaging lens of embodiment 1, wherein, the units of curvature radius, thickness, and focal length are millimeters (mm).

TABLE 1
Embodiment 1: f = 6.82 mm, FOV = 47.5°, TTL = 5.80 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.4960 | 1.3992 | 1.50 | 81.6 | 2.69 | −0.1235 |
| | surface | | | | | | |
| S2 | Aspheric | −8.9138 | 0.0942 | | | | 0.0000 |
| | surface | | | | | | |
| S3 | Aspheric | 6.3657 | 0.3000 | 1.96 | 29.8 | −4.32 | 26.2190 |
| | surface | | | | | | |
| S4 | Aspheric | 2.4501 | 0.2158 | | | | 0.0000 |
| | surface | | | | | | |
| STO | Sphere | Infinity | −0.1237 | | | | 0.0000 |
| S5 | Aspheric | 8.2012 | 0.2500 | 1.65 | 23.5 | −9.79 | 0.0000 |
| | surface | | | | | | |
| S6 | Aspheric | 3.5211 | 1.4072 | | | | 0.0000 |
| | surface | | | | | | |
| S7 | Aspheric | −2.2843 | 0.6372 | 1.68 | 19.2 | −79.08 | 0.0000 |
| | surface | | | | | | |
| S8 | Aspheric | −2.6548 | 0.2033 | | | | 0.0000 |
| | surface | | | | | | |
| S9 | Aspheric | −2.4979 | 0.5954 | 1.55 | 56.1 | −10.21 | 0.0000 |
| | surface | | | | | | |
| S10 | Aspheric | −4.9056 | 0.0300 | | | | 0.0000 |
| | surface | | | | | | |
| S11 | Sphere | Infinity | 0.2100 | 1.52 | 64.2 | | |
| S12 | Sphere | Infinity | 0.5813 | | | | |
| S13 | Sphere | Infinity | | | | | |

Wherein f is the total effective focal length of the optical imaging lens, FOV is the maximum Field of View of the optical imaging lens, and TTL is the on-axis distance from the object-side surface of the first lens to the imaging surface.

In embodiment 1, both an object-side surface and an image-side surface of any one of the first lens E1 to the fifth lens E5 are aspheric surfaces, and the surface type x of each aspheric lens can be defined by, but not limited to, the following aspheric formula:

$$x = \frac{c {h}^{2}}{1 + \sqrt{1 - ( k + 1 ) {c}^{2} {h}^{2}}} + \sum {Aih}^{i} \qquad ( 1 )$$

wherein, x is the distance vector height from a vertex of the aspheric surface when the aspheric surface is at a height of h along the optical axis direction; c is the paraxial curvature of the aspheric surface, c=1/R (that is, the paraxial curvature c is the reciprocal of the curvature radius R in Table 1 above); k is the conic coefficient; and Ai is the correction coefficient of the i-th order of the aspheric surface. Table 2 shows the higher order term coefficients A₄, A₆, A_{B}, A₁₀, A₁₂, A₁₄, A₁₆, A₁₈ and A₂₀ that can be used for each of aspherical mirror surfaces S1-S10 in embodiment 1.

TABLE 2

| Surface | | | | | |
|---|---|---|---|---|---|
| number | A4 | A6 | A8 | A10 | A12 |
| S1 | 5.7623E−03 | −3.7410E−02 | 1.1551E−01 | −2.0119E−01 | 2.1094E−01 |
| S2 | 6.3269E−02 | 4.5240E−02 | −2.4959E−01 | 4.2505E−01 | −4.0415E−01 |
| S3 | −8.6812E−02 | 2.6403E−01 | −6.8765E−01 | 1.3313E+00 | −1.7387E+00 |
| S4 | −1.1529E+−01 | 7.3657E−01 | −3.5139E++00 | 2.4140E+01 | −1.0537E++02 |
| S5 | 2.1217E−01 | −1.9900E+−01 | 4.1635E+00 | −1.8491E++01 | 3.6030E+01 |
| S6 | 2.6485E−01 | −1.1762E+−01 | 1.3006E−01 | 1.1590E+01 | −1.1765E++02 |
| S7 | −2.7139E+−02 | −1.2639E+−01 | 1.5619E−01 | −4.8613E+−02 | −7.6156E+−02 |
| S8 | −5.7115E+−02 | −1.2458E+−01 | 2.0730E−01 | −1.2868E+−01 | 2.8400E−02 |
| S9 | −1.2081E+−01 | −8.4896E+−02 | 3.9412E−01 | −3.9591E+−01 | 1.9830E−01 |
| S10 | −1.4200E+−01 | 8.2508E−02 | 3.4044E−02 | −6.2791E+−02 | 3.4049E−02 |

| Surface | | | | |
|---|---|---|---|---|
| number | A14 | A16 | A18 | A20 |
| S1 | −1.3529E−01 | 5.1513E−02 | −1.0573E−02 | 8.7708E−04 |
| S2 | 2.2877E−01 | −7.5309E−02 | 1.2987E−02 | −8.5645E−04 |
| S3 | 1.5632E+00 | −9.7708E+−01 | 3.9300E−01 | −7.5601E+−02 |
| S4 | 2.7419E+02 | −4.1489E++02 | 3.3717E+02 | −1.1317E++02 |
| S5 | −1.2733E++01 | −6.7633E++01 | 1.0819E+02 | −5.0499E++01 |
| S6 | 5.0273E+02 | −1.1102E++03 | 1.2476E+03 | −5.6481E++02 |
| S7 | 7.7901E−02 | −2.5988E+−02 | 2.9874E−03 | 0.0000E+00 |
| S8 | 2.0707E−03 | −1.4985E+−03 | 1.2712E−04 | 0.0000E+00 |
| S9 | −5.6178E+−02 | 9.0594E−03 | −7.6189E+−04 | 2.4955E−05 |
| S10 | −1.0051E+−02 | 1.7339E−03 | −1.6464E+−04 | 6.6670E−06 |

FIG. 2A shows an longitudinal aberration curve of the optical imaging lens of embodiment 1, which indicates the deviations of light of different wavelengths from a convergent focus point after passing through the lens. FIG. 2B shows an astigmatic curve of the optical imaging lens of embodiment 1, which indicates a tangential image surface curvature and a sagittal image surface curvature. FIG. 2C shows a distortion curve of the optical imaging lens of embodiment 1, which indicates distortion magnitude values corresponding to different image heights. FIG. 2D shows a lateral color curve of the optical imaging lens of embodiment 1, which indicates the deviation of different image heights on the imaging surface of light passing through the lens. It can be seen from FIG. 2A to FIG. 2D that, the optical imaging lens provided in embodiment 1 can achieve good imaging quality.

### Embodiment 2

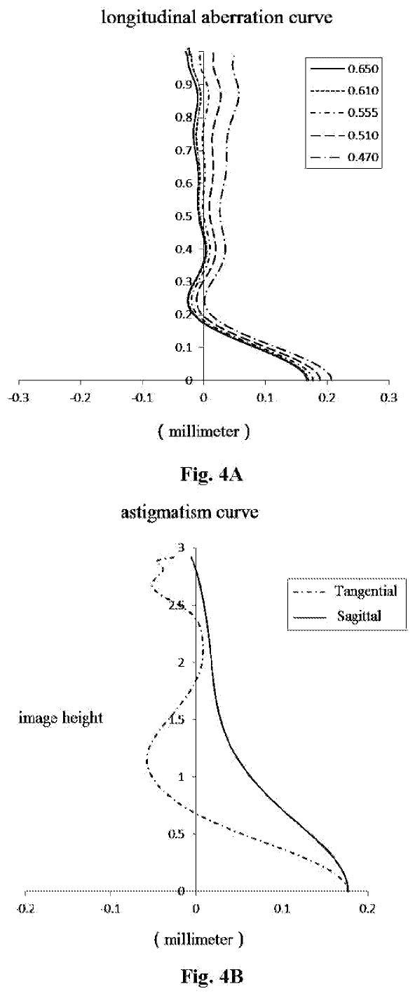

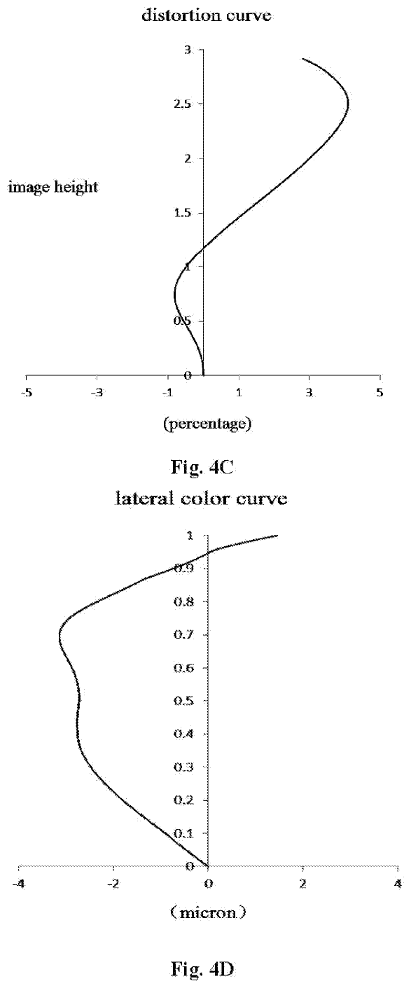

An optical imaging lens according to embodiment 2 of the disclosure is described below with reference to FIG. 3 to FIG. 4D. In this embodiment and the following embodiments, a description similar to that of embodiment 1 will be omitted for the sake of brevity. FIG. 3 shows a schematic view showing a schematic structure view of an optical imaging lens according to embodiment 2 of the disclosure.

As shown in FIG. 3, the optical imaging lens comprises sequentially from an object side to an image side along an optical axis: a first lens E1, a diaphragm STO, a second lens E2, a third lens E3, a fourth lens E4, a fifth lens E5, an optical filter E6 and an imaging surface S13.

The first lens E1 has a positive refractive power, an object-side surface S1 thereof is a convex surface, and an image-side surface S2 is a concave surface. The second lens E2 has a negative refractive power, an object-side surface S3 thereof is a convex surface, and an image-side surface S4 is a concave surface. The third lens E3 has a negative refractive power, an object-side surface S5 thereof is a convex surface, and an image-side surface 6 is a concave surface. The fourth lens E4 has a positive refractive power, an object-side surface S7 thereof is a concave surface, and an image-side surface S8 is a convex surface. The fifth lens E5 has a negative refractive power, an object-side surface S9 thereof is a concave surface, and an image-side surface S10 is a convex surface. The optical filter E6 has an object-side surface S11 and an image-side surface S12. Light from an object sequentially penetrates through each of the surfaces S1 to S12 and is finally imaged on the imaging surface S13.

Table 3 shows basic parameters of the optical imaging lens of embodiment 2, wherein, the units of curvature radius, thickness, and focal length are millimeters (mm). Table 4 shows higher order term coefficients that can be used for each aspherical mirror surfaces in embodiment 2, wherein each aspherical surface type can be defined by equation (1) given in embodiment 1 above.

TABLE 3
Embodiment 2: f = 6.82 mm, FOV = 47.6°, TTL = 5.50 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.6126 | 1.1651 | 1.50 | 81.6 | 3.26 | −0.0395 |
| | surface | | | | | | |
| S2 | Aspheric | 150.0000 | 0.3420 | | | | 99.9900 |
| | surface | | | | | | |
| STO | Sphere | Infinity | 0.0979 | | | | 0.0000 |
| S3 | Aspheric | 4.8020 | 0.3000 | 1.93 | 18.9 | −4.96 | 14.4982 |
| | surface | | | | | | |
| S4 | Aspheric | 2.2842 | 0.0500 | | | | −1.5504 |
| | surface | | | | | | |
| S5 | Aspheric | 5.2350 | 0.2500 | 1.65 | 23.5 | −37.44 | 0.0000 |
| | surface | | | | | | |
| S6 | Aspheric | 4.2202 | 1.3479 | | | | −2.4304 |
| | surface | | | | | | |
| S7 | Aspheric | −2.5317 | 0.5762 | 1.68 | 19.2 | 12.75 | −0.9003 |
| | surface | | | | | | |
| S8 | Aspheric | −2.1380 | 0.1273 | | | | −10.3371 |
| | surface | | | | | | |
| S9 | Aspheric | −2.3184 | 0.2200 | 1.55 | 56.1 | −4.43 | −1.2810 |
| | surface | | | | | | |
| S10 | Aspheric | −57.3224 | 0.0300 | | | | 99.9873 |
| | surface | | | | | | |
| S11 | Sphere | Infinity | 0.2100 | 1.52 | 64.2 | | |
| S12 | Sphere | Infinity | 0.7836 | | | | |
| S13 | Sphere | Infinity | | | | | |

TABLE 4

| Surface | | | | | |
|---|---|---|---|---|---|
| number | A4 | A6 | A8 | A10 | A12 |
| S1 | 1.1256E−02 | −6.7438E+−02 | 1.7666E−01 | −2.8470E+−01 | 2.9178E−01 |
| S2 | 1.9535E−02 | 1.2057E−01 | −5.6653E+−01 | 1.4223E+00 | −2.1762E++00 |
| S3 | −1.9677E+−02 | −1.6325E+−01 | 6.6938E−01 | −1.7056E++00 | 3.0687E+00 |
| S4 | −8.9502E+−02 | 1.2981E+00 | −1.2050E++01 | 7.5284E+01 | −2.7030E++02 |
| S5 | 1.6389E−01 | 4.1191E−01 | −2.1810E++00 | 1.9105E+01 | −7.2533E++01 |
| S6 | 1.1257E−01 | 3.0675E+00 | −3.2300E++01 | 2.1238E+02 | −8.7937E++02 |
| S7 | 4.6314E−02 | −1.8347E+−01 | 1.5104E−01 | 2.1954E−02 | −1.2324E+−01 |
| S8 | −3.6601E+−02 | −1.8044E+−01 | 1.7860E−01 | −5.1504E+−02 | −1.4796E+−02 |
| S9 | −3.4230E+−01 | 3.0146E−01 | −3.0091E+−02 | −1.3668E+−01 | 1.1469E−01 |
| S10 | −4.6303E+−01 | 6.2127E−01 | −4.7039E+−01 | 2.1877E−01 | −6.5215E+−02 |

| Surface | | | | |
|---|---|---|---|---|
| number | A14 | A16 | A18 | A20 |
| S1 | −1.9204E+−01 | 7.8749E−02 | −1.8349E+−02 | 1.8602E−03 |
| S2 | 2.0691E+00 | −1.1896E++00 | 3.7802E−01 | −5.0894E+−02 |
| S3 | −3.7646E++00 | 2.8872E+00 | −1.2071E++00 | 2.0109E−01 |
| S4 | 5.8965E+02 | −7.8553E++02 | 5.9111E+02 | −1.9247E++02 |
| S5 | 1.4703E+02 | −1.7760E++02 | 1.2498E+02 | −3.9772E++01 |
| S6 | 2.2973E+03 | −3.6654E++03 | 3.2546E+03 | −1.2302E++03 |
| S7 | 7.0068E−02 | −1.1833E+−02 | −6.9354E+−05 | 0.0000E+00 |
| S8 | 9.8176E−03 | −1.0848E+−03 | −4.1419E+−05 | 0.0000E+00 |
| S9 | −4.3502E+−02 | 8.6469E−03 | −8.3228E+−04 | 2.6583E−05 |
| S10 | 1.2828E−02 | −1.7280E+−03 | 1.5928E−04 | −7.8554E+−06 |

FIG. 4A shows an longitudinal aberration curve of the optical imaging lens of embodiment 2, which indicates the deviations of light of different wavelengths from a convergent focus point after passing through the lens. FIG. 4B shows an astigmatic curve of the optical imaging lens of embodiment 2, which indicates a tangential image surface curvature and a sagittal image surface curvature. FIG. 4C shows a distortion curve of the optical imaging lens of embodiment 2, which indicates distortion magnitude values corresponding to different image heights. FIG. 4D shows the lateral color curve of the optical imaging lens of embodiment 2, which indicates the deviation of different image heights on the imaging surface of light passing through the lens. It can be seen from FIG. 4A to FIG. 4D that, the optical imaging lens provided in embodiment 2 can achieve good imaging quality.

### Embodiment 3

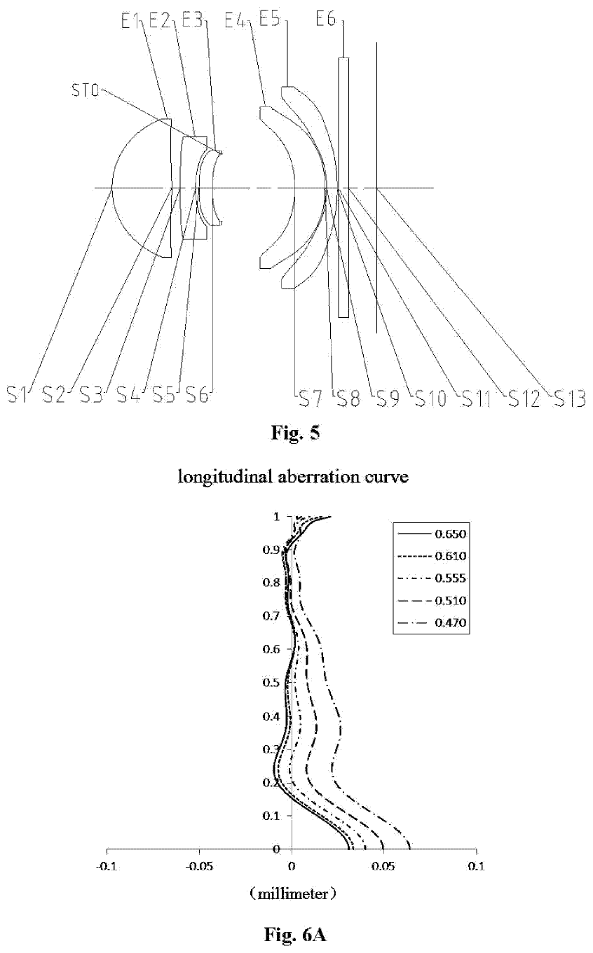

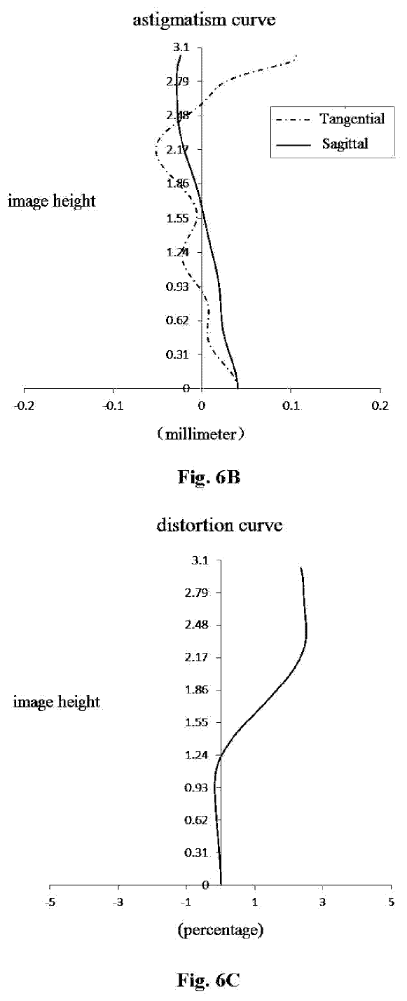

An optical imaging lens according to embodiment 3 of the disclosure is described below with reference to FIG. 5 to FIG. 6D. FIG. 5 shows a schematic structure view of an optical imaging lens according to embodiment 3 of the disclosure.

As shown in FIG. 5, the optical imaging lens comprises sequentially from an object side to an image side along an optical axis: a first lens E1, a second lens E2, a third lens E3, an aperture STO, a fourth lens E4, a fifth lens E5, an optical filter E6, and an imaging surface S13.

The first lens E1 has a positive refractive power, an object-side surface S1 thereof is a convex surface, and an image-side surface S2 is a convex surface. The second lens E2 has a negative refractive power, an object-side surface S3 thereof is a convex surface, and an image-side surface S4 is a concave surface. The third lens E3 has a positive refractive power, an object-side surface S5 thereof is a convex surface, and an image-side surface S6 is a concave surface. The fourth lens E4 has a negative refractive power, an object-side surface S7 thereof is a concave surface, and an image-side surface S8 is a convex surface. The fifth lens E5 has a negative refractive power, an object-side surface S9 thereof is a concave surface, and an image-side surface S10 is a convex surface. The optical filter E6 has an object-side surface S11 and an image-side surface S12. Light from an object sequentially penetrates through each of the surfaces S1 to S12 and is finally imaged on the imaging surface 313.

Table 5 shows basic parameters of the optical imaging lens of embodiment 3, wherein, the units of curvature radius, thickness, and focal length are millimeters (mm). Table 6 shows higher order term coefficients that can be used for each aspherical mirror surfaces in embodiment 3, wherein each aspherical surface type can be defined by equation (1) given in embodiment 1 above.

TABLE 5
Embodiment 3: f = 6.82 mm, FOV = 47.5°, TTL = 5.50 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.4431 | 1.2422 | 1.50 | 81.6 | 2.52 | −0.0586 |
| | surface | | | | | | |
| S2 | Aspheric | −6.9478 | 0.1747 | | | | 0.0000 |
| | surface | | | | | | |
| S3 | Aspheric | 8.8260 | 0.3200 | 1.96 | 29.8 | −2.51 | 26.1285 |
| | surface | | | | | | |
| S4 | Aspheric | 1.8528 | 0.0696 | | | | 0.0000 |
| | surface | | | | | | |
| S5 | Aspheric | 3.3807 | 0.2821 | 1.65 | 23.5 | 56.75 | 0.0000 |
| | surface | | | | | | |
| S6 | Aspheric | 3.6039 | 0.1794 | | | | 0.0000 |
| | surface | | | | | | |
| STO | Sphere | Infinity | 1.5353 | | | | 0.0000 |
| S7 | Aspheric | −2.0271 | 0.6244 | 1.68 | 19.2 | −54.64 | 0.0000 |
| | surface | | | | | | |
| S8 | Aspheric | −2.4113 | 0.0323 | | | | 0.0000 |
| | surface | | | | | | |
| S9 | Aspheric | −2.3077 | 0.2200 | 1.55 | 56.1 | −8.79 | 0.0000 |
| | surface | | | | | | |
| S10 | Sphere | −4.5940 | 0.0300 | | | | 0.0000 |
| S11 | Sphere | Infinity | 0.2100 | 1.52 | 64.2 | | |
| S12 | Sphere | Infinity | 0.5800 | | | | |
| S13 | Sphere | Infinity | | | | | |

TABLE 6

| Surface | | | | | |
|---|---|---|---|---|---|
| number | A4 | A6 | A8 | A10 | A12 |
| S1 | 6.9303E−04 | −2.3744E+−02 | 7.2845E−02 | −1.3669E+−01 | 1.5326E−01 |
| S2 | 3.9909E−02 | 1.3709E−01 | −4.7276E+−01 | 8.7485E−01 | −1.0531E++00 |
| S3 | −1.7233E+−01 | 5.7773E−01 | −1.3558E++00 | 2.4850E+00 | −3.4963E++00 |
| S4 | −2.8966E+−01 | 1.7077E+00 | −5.7288E++00 | 2.7190E+01 | −1.1128E++02 |
| S5 | 1.6740E−01 | 1.0444E+00 | −2.1966E++00 | 1.0091E+01 | −5.9108E++01 |
| S6 | 2.8311E−01 | 1.3956E+00 | −1.6805E++01 | 1.2338E+02 | −5.6909E++02 |
| S7 | −4.4621E+−02 | 1.2012E−01 | −3.4243E+−01 | 4.5395E−01 | −3.4728E+−01 |
| S8 | −9.0743E+−02 | −1.6577E+−02 | 7.0078E−02 | −3.5618E+−02 | −5.3765E+−03 |
| S9 | −8.6420E+−02 | −1.9671E+−01 | 5.4390E−01 | −4.9329E+−01 | 2.3232E−01 |
| S10 | −6.9651E+−02 | −2.1707E+−02 | 1.1949E−01 | −1.0618E+−01 | 4.8348E−02 |

| Surface | | | | |
|---|---|---|---|---|
| number | A14 | A16 | A18 | A20 |
| S1 | −1.0506E+−01 | 4.2170E−02 | −8.8639E+−03 | 6.8276E−04 |
| S2 | 8.3217E−01 | −4.1503E+−01 | 1.1831E−01 | −1.4653E+−02 |
| S3 | 3.6754E+00 | −2.6632E++00 | 1.1631E+00 | −2.2779E+−01 |
| S4 | 2.8419E+02 | −4.2314E++02 | 3.4103E+02 | −1.1461E++02 |
| S5 | 1.8204E+02 | −2.9959E++02 | 2.5781E+02 | −9.0936E++01 |
| S6 | 1.6546E+03 | −2.9375E++03 | 2.9016E+03 | −1.2159E++03 |
| S7 | 1.5230E−01 | −3.4413E+−02 | 3.0797E−03 | 0.0000E+00 |
| S8 | 7.2714E−03 | −1.5004E+−03 | 8.5039E−05 | 0.0000E+00 |
| S9 | −6.2808E+−02 | 9.7801E−03 | −8.0601E+−04 | 2.6565E−05 |
| S10 | −1.3248E+−02 | 2.2195E−03 | −2.1101E+−04 | 8.7838E−06 |

FIG. 6A shows an longitudinal aberration curve of the optical imaging lens of embodiment 3, which indicates the deviations of light of different wavelengths from a convergent focus point after passing through the lens. FIG. 6B shows an astigmatic curve of the optical imaging lens of embodiment 3, which indicates a tangential image surface curvature and a sagittal image surface curvature. FIG. 6C shows a distortion curve of the optical imaging lens of embodiment 3, which indicates distortion magnitude values corresponding to different image heights. FIG. 6D shows the lateral color curve of the optical imaging lens of embodiment 3, which indicates the deviation of different image heights on the imaging surface of light passing through the lens. It can be seen from FIG. 6A to FIG. 6D that, the optical imaging lens provided in embodiment 3 can achieve good imaging quality.

### Embodiment 4

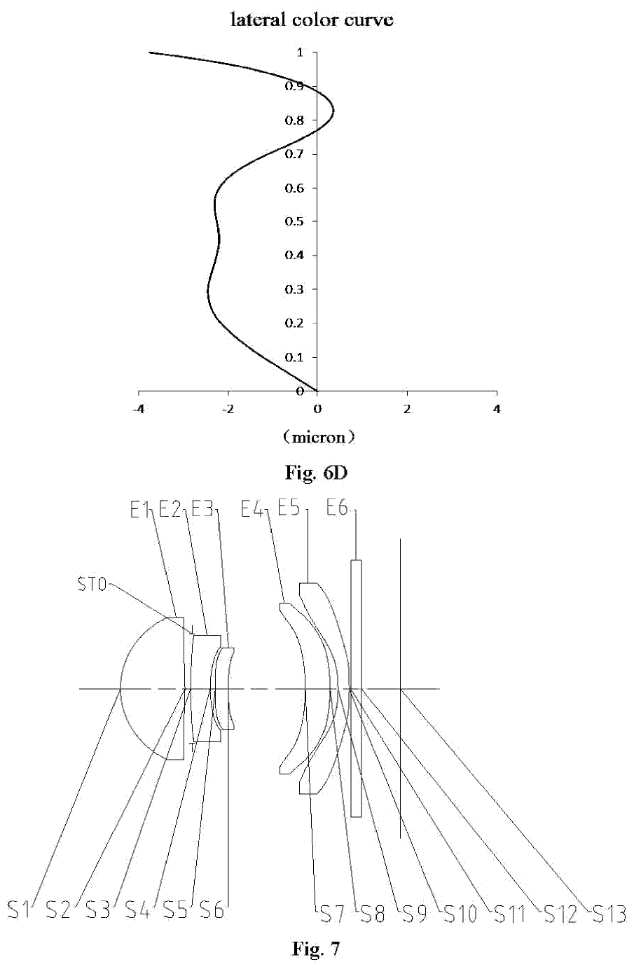

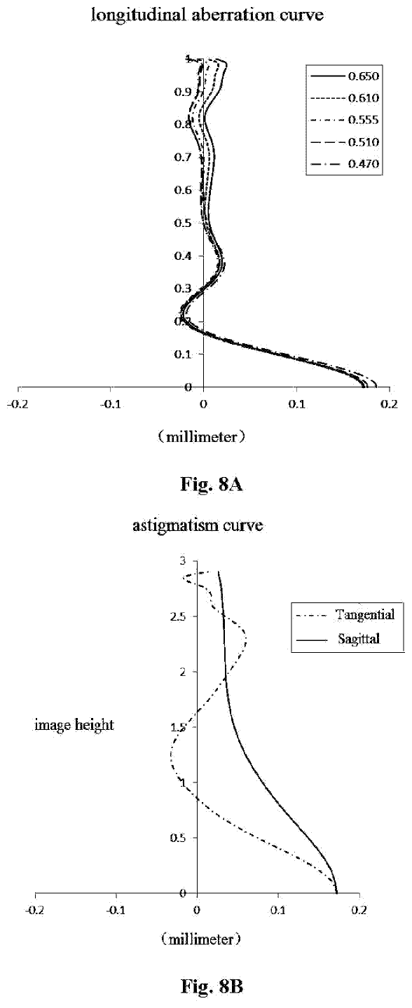

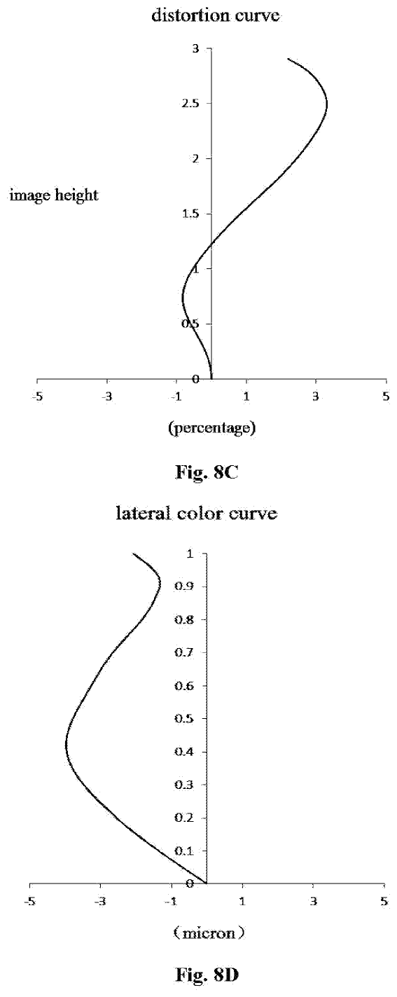

An optical imaging lens according to embodiment 4 of the disclosure is described below with reference to FIG. 7 to FIG. 8D. FIG. 7 shows a schematic structure view of an optical imaging lens according to embodiment 4 of the disclosure.

As shown in FIG. 7, the optical imaging lens comprises sequentially from an object side to an image side along an optical axis: a first lens E1, a diaphragm STO, a second lens E2, a third lens E3, a fourth lens E4, a fifth lens E5, an optical filter E6 and an imaging surface S13.

The first lens E1 has a positive refractive power, an object-side surface S1 thereof is a convex surface, and an image-side surface S2 is a convex surface. The second lens E2 has a negative refractive power, an object-side surface S3 thereof is a convex surface, and an image-side surface S4 is a concave surface. The third lens E3 has a negative refractive power, an object-side surface S5 thereof is a convex surface, and an image-side surface S6 is a concave surface. The fourth lens E4 has a positive refractive power, an object-side surface S7 thereof is a concave surface, and an image-side surface S8 is a convex surface. The fifth lens E5 has a negative refractive power, an object-side surface S9 thereof is a concave surface, and an image-side surface S10 is a convex surface. The optical filter E6 has an object-side surface S11 and an image-side surface S12. Light from an object sequentially penetrates through each of the surfaces S1 to S12 and is finally imaged on the imaging surface S13.

Table 7 shows basic parameters of the optical imaging lens of embodiment 4, wherein, the units of curvature radius, thickness, and focal length are millimeters (mm). Table 8 shows higher order term coefficients that can be used for each aspherical mirror surfaces in embodiment 4, wherein each aspherical surface type can be defined by equation (1) given in embodiment 1 above.

TABLE 7
Embodiment 4: f = 6.82 mm, FOV = 47.6°, TTL = 5.45 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.4534 | 1.2565 | 1.49 | 70.4 | 2.57 | −0.0591 |
| | surface | | | | | | |
| S2 | Aspheric | −6.6623 | 0.1438 | | | | −25.9588 |
| | surface | | | | | | |
| STO | Sphere | Infinity | −0.0331 | | | | 0.0000 |
| S3 | Aspheric | 6.7300 | 0.3847 | 1.96 | 29.8 | −3.25 | 16.3671 |
| | surface | | | | | | |
| S4 | Aspheric | 2.0697 | 0.0997 | | | | −2.7797 |
| | surface | | | | | | |
| S5 | Aspheric | 50.2648 | 0.2500 | 1.65 | 23.5 | −15.14 | 0.0000 |
| | surface | | | | | | |
| S6 | Aspheric | 8.1465 | 1.5011 | | | | 40.0360 |
| | surface | | | | | | |
| S7 | Aspheric | −3.6261 | 0.4768 | 1.68 | 19.2 | 83.33 | −0.5593 |
| | surface | | | | | | |
| S8 | Aspheric | −3.5882 | 0.1573 | | | | −33.1849 |
| | surface | | | | | | |
| S9 | Aspheric | −2.9155 | 0.2200 | 1.55 | 56.1 | −6.23 | −1.6263 |
| | surface | | | | | | |
| S10 | Aspheric | −20.8728 | 0.0300 | | | | 72.3997 |
| | surface | | | | | | |
| S11 | Sphere | Infinity | 0.2100 | 1.52 | 64.2 | | |
| S12 | Sphere | Infinity | 0.7531 | | | | |
| S13 | Sphere | Infinity | | | | | |

TABLE 8

| Surface | | | | | |
|---|---|---|---|---|---|
| number | A4 | A6 | A8 | A10 | A12 |
| S1 | 1.1518E−02 | −6.3008E+−02 | 1.6856E−01 | −2.7608E+−01 | 2.8562E−01 |
| S2 | 6.7735E−02 | 2.6137E−02 | −4.2378E+−01 | 1.2935E+00 | −2.1180E++00 |
| S3 | −3.9743E+−02 | −1.8848E+−01 | 9.6762E−01 | −2.4597E++00 | 4.0921E+00 |
| S4 | −1.0185E+−01 | 1.2807E+00 | −1.1757E++01 | 7.1732E+01 | −2.5824E++02 |
| S5 | 3.1177E−01 | 2.2664E−01 | −3.2818E++00 | 2.1925E+01 | −7.4885E++01 |
| S6 | 1.8225E−01 | 3.2564E+00 | −3.5528E++01 | 2.2780E+02 | −9.1901E++02 |
| S7 | 2.4993E−02 | −1.2230E+−01 | 1.0353E−01 | −1.7675E+−02 | −3.0797E+−02 |
| S8 | −7.0615E+−02 | −8.3485E+−02 | 7.7838E−02 | −1.4962E+−02 | −9.8435E+−03 |
| S9 | −3.5590E+−01 | 3.3915E−01 | −7.7053E+−02 | −1.0318E+01 | 1.0144E−01 |
| S10 | −4.0933E+−01 | 5.3779E−01 | −3.8172E+01 | 1.6937E−01 | −5.0411E+−02 |

| Surface | | | | |
|---|---|---|---|---|
| number | A14 | A16 | A18 | A20 |
| S1 | −1.8929E+−01 | 7.8126E−02 | −1.8349E+−02 | 1.8602E−03 |
| S2 | 2.0597E+00 | −1.1900E++00 | 3.7802E−01 | −5.0894E+−02 |
| S3 | −4.4850E++00 | 3.0946E+00 | −1.2071E++00 | 2.0109E−01 |
| S4 | 5.7371E+02 | −7.7776E++02 | 5.9111E+02 | −1.9247E++02 |
| S5 | 1.4807E+02 | −1.7817E++02 | 1.2498E+02 | −3.9772E++01 |
| S6 | 2.3488E+03 | −3.6921E++03 | 3.2546E+03 | −1.2302E++03 |
| S7 | 1.7908E−02 | −2.5422E+−03 | −6.9354E+−05 | 0.0000E+00 |
| S8 | 4.3653E−03 | −2.9624E+−04 | −4.1419E+−05 | 0.0000E+00 |
| S9 | −4.0863E+−02 | 8.4392E−03 | −8.3228E+−04 | 2.6583E−05 |
| S10 | 1.0561E−02 | −1.5887E+−03 | 1.5928E−04 | −7.8554E+−06 |

FIG. 8A shows an longitudinal aberration curve of the optical imaging lens of embodiment 4, which indicates the deviations of light of different wavelengths from a convergent focus point after passing through the lens. FIG. 8B shows an astigmatic curve of the optical imaging lens of embodiment 4, which indicates a tangential image surface curvature and a sagittal image surface curvature. FIG. 8C shows a distortion curve of the optical imaging lens of embodiment 4, which indicates distortion magnitude values corresponding to different image heights. FIG. 8D shows the lateral color curve of the optical imaging lens of embodiment 4, which indicates the deviation of different image heights on the imaging surface of light passing through the lens. It can be seen from FIGS. 8A to 8D that, the optical imaging lens provided in embodiment 4 can achieve good imaging quality.

### Embodiment 5

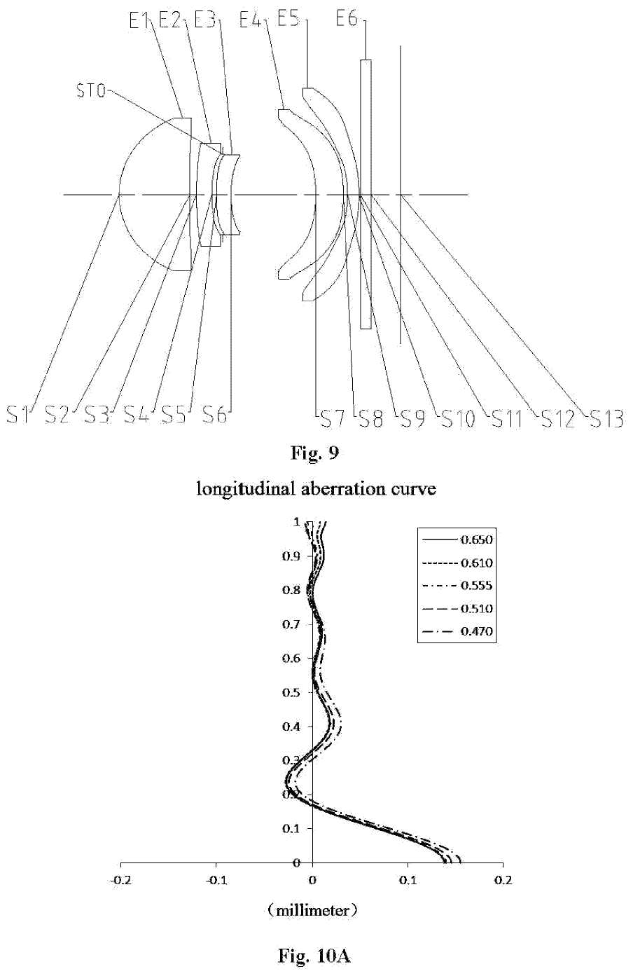

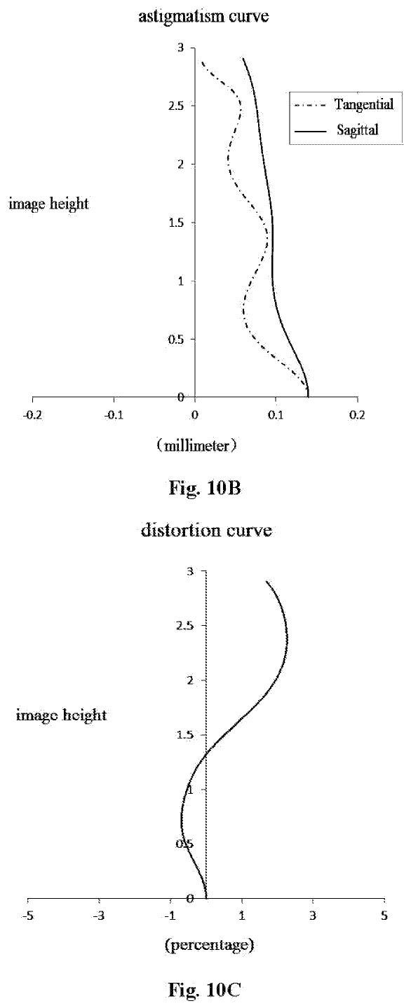

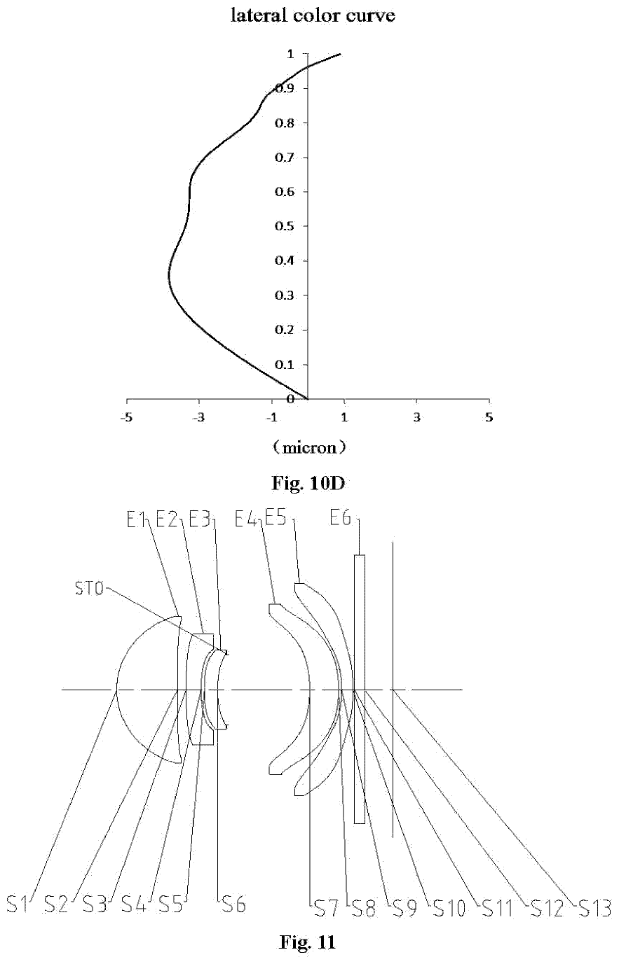

An optical imaging lens according to embodiment 5 of the disclosure is described below with reference to FIG. 9 to FIG. 10D. FIG. 9 shows a schematic structure view of an optical imaging lens according to embodiment 5 of the disclosure.

As shown in FIG. 9, an optical imaging lens includes sequentially from an object side to an image side along an optical axis: a first lens E1, a second lens E2, a diaphragm STO, a third lens E3, a fourth lens E4, a fifth lens E5, an optical filter E6 and an imaging surface S13.

The first lens E1 has a positive refractive power, an object-side surface S1 thereof is a convex surface, and an image-side surface S2 is a concave surface. The second lens E2 has a negative refractive power, an object-side surface S3 thereof is a convex surface, and an image-side surface S4 is a concave surface. The third lens E3 has a negative refractive power, an object-side surface S5 thereof is a convex surface, and an image-side surface S6 is a concave surface. The fourth lens E4 has a negative refractive power, an object-side surface S7 thereof is a concave surface, and an image-side surface S8 is a convex surface. The fifth lens E5 has a negative refractive power, an object-side surface S9 thereof is a concave surface, and an image-side surface S10 is a convex surface. The optical filter E6 has an object-side surface S11 and an image-side surface S12. Light from an object sequentially penetrates through each of the surfaces S1 to S12 and is finally imaged on the imaging surface S13.

Table 9 shows basic parameters of the optical imaging lens of embodiment 5, wherein, the units of curvature radius, thickness, and focal length are millimeters (mm). Table 10 shows higher order term coefficients that can be used for each aspherical mirror surfaces in embodiment 5, wherein each aspherical surface type can be defined by equation (1) given in embodiment 1 above.

TABLE 9
Embodiment 5: f = 6.81 mm, FOV = 47.5°, TTL = 5.50 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.4939 | 1.3813 | 1.50 | 81.6 | 3.01 | −0.1735 |
| | surface | | | | | | |
| S2 | Aspheric | 300.0000 | 0.1288 | | | | −99.9900 |
| | surface | | | | | | |
| S3 | Aspheric | 5.5607 | 0.3000 | 1.96 | 29.8 | −7.23 | 20.0506 |
| | surface | | | | | | |
| S4 | Aspheric | 3.0022 | 0.2070 | | | | 4.1081 |
| | surface | | | | | | |
| STO | Sphere | Infinity | −0.1117 | | | | 0.0000 |
| S5 | Aspheric | 9.2530 | 0.2836 | 1.65 | 23.5 | −6.51 | 72.0523 |
| | surface | | | | | | |
| S6 | Aspheric | 2.8499 | 1.6546 | | | | −2.8417 |
| | surface | | | | | | |
| S7 | Aspheric | −2.4895 | 0.5370 | 1.68 | 19.2 | −38.13 | 0.2070 |
| | surface | | | | | | |
| S8 | Aspheric | −2.9949 | 0.0838 | | | | 0.8003 |
| | surface | | | | | | |
| S9 | Aspheric | −2.3145 | 0.2200 | 1.55 | 56.1 | −10.00 | −0.1271 |
| | surface | | | | | | |
| S10 | Aspheric | −4.1535 | 0.0300 | | | | 1.1228 |
| | surface | | | | | | |
| S11 | Sphere | Infinity | 0.2100 | 1.52 | 64.2 | | |
| S12 | Sphere | Infinity | 0.5756 | | | | |
| S13 | Sphere | Infinity | | | | | |

TABLE 10

| Surface | | | | | |
|---|---|---|---|---|---|
| number | A4 | A6 | A8 | A10 | A12 |
| S1 | 6.8643E−03 | −1.8630E+−02 | 2.9644E−02 | −9.8131E+−03 | −2.8979E+−02 |
| S2 | −1.6139E+−02 | 1.2930E−01 | −3.4080E+−01 | 6.0417E−01 | −7.0851E+−01 |
| S3 | −1.0088E+−01 | 1.9026E−01 | −2.6545E+−01 | 3.0610E−01 | −1.3951E+−01 |
| S4 | −3.7424E+−02 | 4.2752E−01 | 6.6553E−02 | −5.8995E++00 | 3.5714E+01 |
| S5 | 3.8506E−01 | −2.0901E++00 | 2.0901E+01 | −1.1695E++02 | 4.0415E+02 |
| S6 | 5.3131E−02 | 5.0309E+00 | −5.8738E++01 | 3.9302E+02 | −1.6206E++03 |
| S7 | −4.9908E+−02 | 1.4878E−01 | −5.4712E+−01 | 7.8423E−01 | −5.8336E+−01 |
| S8 | −6.5732E+−02 | −7.6824E+−03 | −8.5777E+−02 | 1.6458E−01 | −1.2832E+−01 |
| S9 | −1.0461E+−01 | −1.6041E+−01 | 5.6054E−01 | −5.5975E+−01 | 2.8583E−01 |
| S10 | −1.6153E+−01 | 1.1216E−01 | 9.4160E−02 | −1.6283E+−01 | 9.7017E−02 |

| Surface | | | | |
|---|---|---|---|---|
| number | A14 | A16 | A18 | A20 |
| S1 | 4.3991E−02 | −2.7581E+−02 | 8.4492E−03 | −1.0397E+−03 |
| S2 | 5.3848E−01 | −2.5532E+−01 | 6.8560E−02 | −7.9483E+−03 |
| S3 | −2.1771E+−01 | 3.7918E−01 | −2.2247E+−01 | 4.7248E−02 |
| S4 | −1.0849E++02 | 1.8279E+02 | −1.6334E++02 | 6.1121E+01 |
| S5 | −8.7758E++02 | 1.1639E+03 | −8.6175E++02 | 2.7349E+02 |
| S6 | 4.1690E+03 | −6.5097E++03 | 5.6374E+03 | −2.0744E++03 |
| S7 | 2.3030E−01 | −4.3860E+−02 | 2.9874E−03 | 0.0000E+00 |
| S8 | 5.2885E−02 | −1.2760E+−02 | 1.8390E−03 | −1.2248E+−04 |
| S9 | −8.3643E+−02 | 1.4165E−02 | −1.2888E+−03 | 4.8592E−05 |
| S10 | −3.1631E+−02 | 6.0027E−03 | −6.2408E+−04 | 2.7541E−05 |

FIG. 10A shows an longitudinal aberration curve of the optical imaging lens of embodiment 5, which indicates the deviations of light of different wavelengths from a convergent focus point after passing through the lens. FIG. 10B shows an astigmatic curve of the optical imaging lens of embodiment 5, which indicates a tangential image surface curvature and a sagittal image surface curvature. FIG. 10C shows a distortion curve of the optical imaging lens of embodiment 5, which indicates distortion magnitude values corresponding to different image heights. FIG. 10D shows the lateral color curve of the optical imaging lens of embodiment 5, which indicates the deviation of different image heights on the imaging surface of light passing through the lens. It can be seen from FIG. 10A to FIG. 10D that, the optical imaging lens provided in embodiment 5 can achieve good imaging quality.

### Embodiment 6

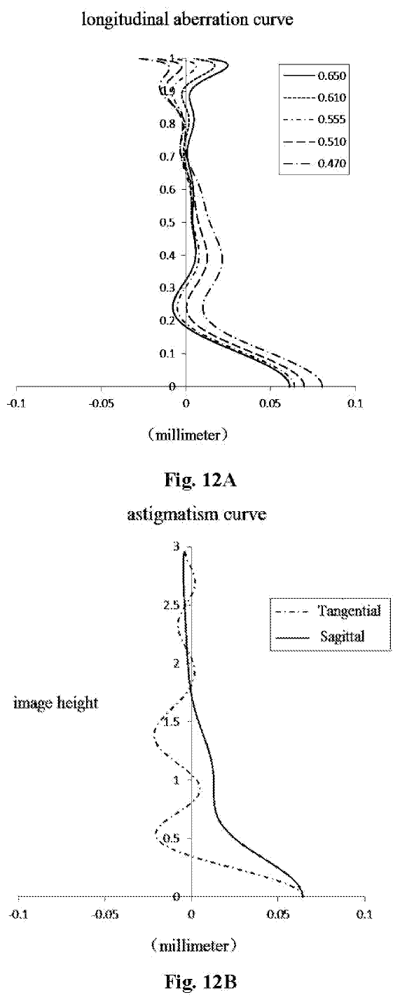

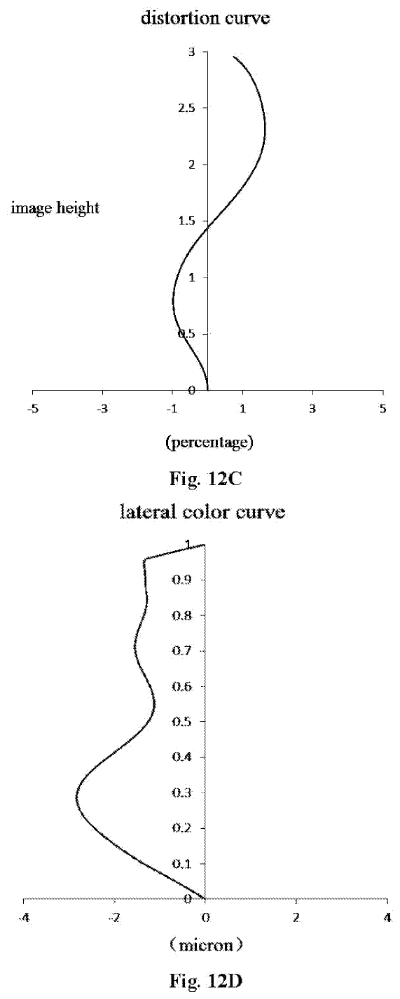

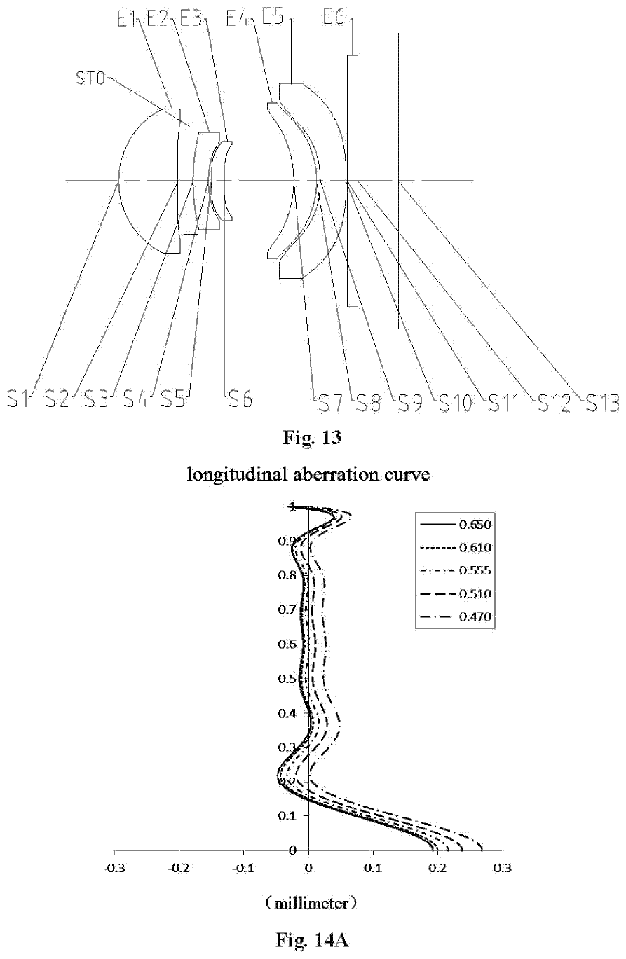

An optical imaging lens according to embodiment 6 of the disclosure is described below with reference to FIG. 11 to FIG. 12D. FIG. 11 shows a schematic structure view of an optical imaging lens according to embodiment 6 of the disclosure.

As shown in FIG. 11, an optical imaging lens includes sequentially from an object side to an image side along an optical axis: a first lens E1, a second lens E2, a third lens E3, an aperture STO, a fourth lens E4, a fifth lens E5, an optical filter E6, and an imaging surface S13.

The first lens E1 has a positive refractive power, an object-side surface S1 thereof is a convex surface, and an image-side surface S2 is a concave surface. The second lens E2 has a negative refractive power, an object-side surface S3 thereof is a convex surface, and an image-side surface S4 is a concave surface. The third lens E3 has a negative refractive power, an object-side surface S5 thereof is a convex surface, and an image-side surface S6 is a concave surface. The fourth lens E4 has a positive refractive power, an object-side surface S7 thereof is a concave surface, and an image-side surface S8 is a convex surface. The fifth lens E5 has a negative refractive power, an object-side surface S9 thereof is a concave surface, and an image-side surface S10 is a convex surface. The optical filter E6 has an object-side surface S11 and an image-side surface 12. Light from an object sequentially penetrates through each of the surfaces S1 to S2 and is finally imaged on the imaging surface 313.

Table 11 shows a basic parameter table of the optical imaging lens of embodiment 6, wherein, the units of curvature radius, thickness, and focal length are millimeters (mm). Table 12 shows higher order term coefficients that can be used for each aspherical mirror surfaces in embodiment 6, wherein each aspherical surface type can be defined by equation (1) given in embodiment 1 above.

TABLE 11
Embodiment 6: f = 6.81 mm, FOV = 47.5°, TTL = 5.50 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.4307 | 1.2073 | 1.50 | 81.6 | 2.90 | −0.0866 |
| | surface | | | | | | |
| S2 | Aspheric | 114.1051 | 0.1712 | | | | −99.9900 |
| | surface | | | | | | |
| S3 | Aspheric | 6.5356 | 0.3000 | 1.96 | 29.8 | −5.39 | 31.6906 |
| | surface | | | | | | |
| S4 | Aspheric | 2.8176 | 0.0687 | | | | 5.6654 |
| | surface | | | | | | |
| S5 | Aspheric | 4.2180 | 0.2604 | 1.65 | 23.5 | −8.47 | 0.5318 |
| | surface | | | | | | |
| S6 | Aspheric | 2.3201 | 0.1920 | | | | −8.2672 |
| | surface | | | | | | |
| STO | Sphere | Infinity | 1.6456 | | | | 0.0000 |
| S7 | Aspheric | −2.1603 | 0.5716 | 1.68 | 19.2 | 45.83 | 0.1716 |
| | surface | | | | | | |
| S8 | Aspheric | −2.2356 | 0.0632 | | | | −0.1321 |
| | surface | | | | | | |
| S9 | Aspheric | −2.2628 | 0.2200 | 1.55 | 56.1 | −7.10 | −0.0994 |
| | surface | | | | | | |
| S10 | Aspheric | −5.6238 | 0.0300 | | | | 0.8614 |
| | surface | | | | | | |
| S11 | Sphere | Infinity | 0.2100 | 1.52 | 64.2 | | |
| S12 | Sphere | Infinity | 0.5600 | | | | |
| S13 | Sphere | Infinity | | | | | |

TABLE 12

| Surface | | | | | |
|---|---|---|---|---|---|
| number | A4 | A6 | A8 | A10 | A12 |
| S1 | 6.1560E−03 | −4.5433E+−02 | 1.2624E−01 | −2.1418E+−01 | 2.2551E−01 |
| S2 | −4.1817E+−02 | 2.1617E−01 | −4.5913E+−01 | 6.5448E−01 | −6.3916E+−01 |
| S3 | −1.5332E+−01 | 6.3636E−01 | −1.5828E++00 | 2.6835E+00 | −3.0818E++00 |
| S4 | −1.2244E+−01 | 2.0928E+00 | −9.9513E++00 | 4.2885E+01 | −1.5088E++02 |
| S5 | 2.4745E−01 | 1.2322E+00 | −4.4548E++00 | 1.1191E+01 | −4.1888E++01 |
| S6 | 3.0230E−01 | 8.7922E−01 | −1.1146E++01 | 7.6111E+01 | −3.4733E++02 |
| S7 | 2.0699E−02 | −1.7013E+−01 | 2.6720E−01 | −3.4760E+−01 | 3.0442E−01 |
| S8 | 5.5070E−02 | −3.4438E+−01 | 3.9319E−01 | −2.4010E+−01 | 9.1388E−02 |
| S9 | −1.2595E+−01 | −1.6749E+−02 | 2.0337E−01 | −1.6847E+−01 | 5.7137E−02 |
| S10 | −2.9110E+−01 | 4.5188E−01 | −3.7037E+−01 | 1.9460E−01 | −6.9960E+−02 |

| Surface | | | | |
|---|---|---|---|---|
| number | A14 | A16 | A18 | A20 |
| S1 | −1.4870E+−01 | 5.8970E−02 | −1.2674E+−02 | 1.0877E−03 |
| S2 | 4.2111E−01 | −1.7888E+−01 | 4.4224E−02 | −4.8130E+−03 |
| S3 | 2.3769E+00 | −1.2013E++00 | 3.7262E−01 | −5.7742E+−02 |
| S4 | 3.6561E+02 | −5.4608E++02 | 4.5054E+02 | −1.5599E++02 |
| S5 | 1.4250E+02 | −2.8336E++02 | 2.9152E+02 | −1.2074E++02 |
| S6 | 1.0461E+03 | −1.9697E++03 | 2.0838E+03 | −9.3929E++02 |
| S7 | −1.5980E+−01 | 4.5398E−02 | −5.2799E+−03 | 0.0000E+00 |
| S8 | −2.5255E+−02 | 5.0370E−03 | −4.8302E+−04 | 0.0000E+00 |
| S9 | −6.4845E+−03 | −9.6558E+−04 | 3.1947E−04 | −2.3385E+−05 |
| S10 | 1.7079E−02 | −2.7068E+−03 | 2.5113E−04 | −1.0337E+−05 |

FIG. 12A shows an longitudinal aberration curve of the optical imaging lens of embodiment 6, which indicates the deviations of light of different wavelengths from a convergent focus point after passing through the lens. FIG. 12B shows an astigmatic curve of the optical imaging lens of embodiment 6, which indicates a tangential image surface curvature and a sagittal image surface curvature. FIG. 12C shows a distortion curve of the optical imaging lens of embodiment 6, which indicates distortion magnitude values corresponding to different image heights. FIG. 12D shows the lateral color curve of the optical imaging lens of embodiment 6, which indicates the deviation of different image heights on the imaging surface of light passing through the lens. It can be seen from FIG. 12A to FIG. 12D that, the optical imaging lens provided in embodiment 6 can achieve good imaging quality.

### Embodiment 7

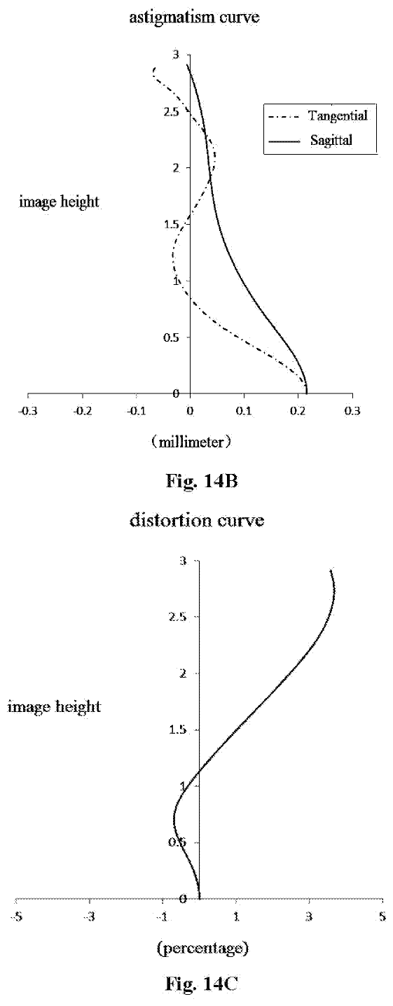

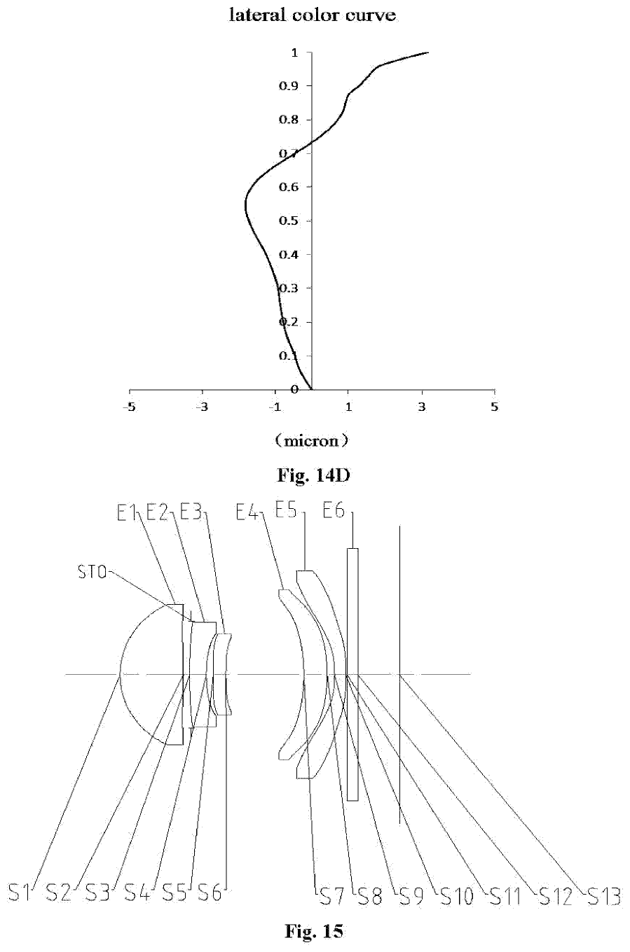

An optical imaging lens according to embodiment 7 of the disclosure is described below with reference to FIGS. 13 to 14D. FIG. 13 shows a schematic structure view of an optical imaging lens according to embodiment 7 of the disclosure.

As shown in FIG. 13, the optical imaging lens comprises sequentially from an object side to an image side along an optical axis: a first lens E1, a diaphragm STO, a second lens E2, a third lens E3, a fourth lens E4, a fifth lens E5, an optical filter E6 and an imaging surface S13.

The first lens E1 has a positive refractive power, an object-side surface S1 thereof is a convex surface, and an image-side surface S2 is a convex surface. The second lens E2 has a negative refractive power, an object-side surface S3 thereof is a convex surface, and an image-side surface S4 is a concave surface. The third lens E3 has a positive refractive power, an object-side surface S5 thereof is a convex surface, and an image-side surface S6 is a concave surface. The fourth lens E4 has a positive refractive power, an object-side surface S7 thereof is a concave surface, and an image-side surface S8 is a convex surface. The fifth lens E5 has a negative refractive power, an object-side surface S9 thereof is a concave surface, and an image-side surface Sa is a convex surface. The optical filter E6 has an object-side surface S11 and an image-side surface S12. Light from an object sequentially penetrates through each of the surfaces S1 to S12 and is finally imaged on the imaging surface S13.

Table 13 shows basic parameters of the optical imaging lens of embodiment 7, wherein, the units of curvature radius, thickness, and focal length are millimeters (mm). Table 14 shows higher order term coefficients that can be used for each aspherical mirror surfaces in embodiment 7, wherein each aspherical surface type can be defined by equation (1) given in embodiment 1 above.

TABLE 13
Embodiment 7: f = 6.82 mm, FOV = 47.6°, TTL = 5.50 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.5897 | 1.1654 | 1.50 | 81.6 | 2.85 | −0.0206 |
| | surface | | | | | | |
| S2 | Aspheric | −9.9960 | 0.2539 | | | | −99.9900 |
| | surface | | | | | | |
| STO | Sphere | Infinity | 0.0475 | | | | 0.0000 |
| S3 | Aspheric | 4.7909 | 0.3000 | 1.93 | 20.9 | −3.24 | 18.9107 |
| | surface | | | | | | |
| S4 | Aspheric | 1.7940 | 0.0562 | | | | −0.4512 |
| | surface | | | | | | |
| S5 | Aspheric | 3.8650 | 0.2500 | 1.65 | 23.5 | 62.24 | 15.8544 |
| | surface | | | | | | |
| S6 | Aspheric | 4.1695 | 1.3741 | | | | 27.7360 |
| | surface | | | | | | |
| S7 | Aspheric | −2.0087 | 0.4479 | 1.68 | 19.2 | 11.74 | −2.2451 |
| | surface | | | | | | |
| S8 | Aspheric | −1.7482 | 0.0736 | | | | −7.0373 |
| | surface | | | | | | |
| S9 | Aspheric | −2.4723 | 0.5035 | 1.55 | 56.1 | −4.65 | −0.7531 |
| | surface | | | | | | |
| S10 | Aspheric | −100.6197 | 0.0300 | | | | −99.9900 |
| | surface | | | | | | |
| S11 | Sphere | Infinity | 0.2100 | 1.52 | 64.2 | | |
| S12 | Sphere | Infinity | 0.7879 | | | | |
| S13 | Sphere | Infinity | | | | | |

TABLE 14

| Surface | | | | | |
|---|---|---|---|---|---|
| number | A4 | A6 | A8 | A10 | A12 |
| S1 | 1.5045E−02 | −9.6935E+−02 | 2.9916E−01 | −5.5987E+−01 | 6.5945E−01 |
| S2 | 9.5942E−02 | 7.2559E−02 | −7.5683E+−01 | 2.1195E+00 | −3.2923E++00 |
| S3 | 1.5211E−01 | −8.5734E+−01 | 3.1453E+00 | −8.7924E++00 | 1.7138E+01 |
| S4 | 1.1898E−01 | 6.8398E−01 | −1.5305E++01 | 1.1245E+02 | −4.3056E++02 |
| S5 | 2.8649E−01 | −2.6855E+−01 | −1.5634E++00 | 2.7027E+01 | −1.0874E++02 |
| S6 | 2.8397E−02 | 4.1536E+00 | −4.7273E++01 | 3.2670E+02 | −1.3904E++03 |
| S7 | 8.1579E−02 | −4.2829E+−01 | 9.4226E−01 | −1.3067E++00 | 1.1164E+00 |
| S8 | −1.3646E+−01 | −1.1875E+−03 | 3.0669E−01 | −5.8086E+−01 | 4.7158E−01 |
| S9 | −3.4849E+−01 | 5.1942E−01 | −2.4723E+−01 | −3.2489E+−01 | 4.9926E−01 |
| S10 | −3.1446E+−01 | 4.4615E−01 | −4.4867E+−01 | 2.9783E−01 | −1.3303E+−01 |

| Surface | | | | |
|---|---|---|---|---|
| number | A14 | A16 | A18 | A20 |
| S1 | −4.9127E+−01 | 2.2442E−01 | −5.7341E+−02 | 6.2836E−03 |
| S2 | 3.0979E+00 | −1.7515E++00 | 5.4777E−01 | −7.2826E+−02 |
| S3 | −2.2139E++01 | 1.7946E+01 | −8.2469E++00 | 1.6306E+00 |
| S4 | 9.7319E+02 | −1.3175E++03 | 9.9200E+02 | −3.1976E++02 |
| S5 | 2.1283E+02 | −2.2745E++02 | 1.2786E+02 | −2.9357E++01 |
| S6 | 3.6853E+03 | −5.9327E++03 | 5.3092E+03 | −2.0271E++03 |
| S7 | −5.6422E+−01 | 1.5391E−01 | −1.7329E+−02 | 0.0000E+00 |
| S8 | −1.9187E+−01 | 3.8103E−02 | −2.8640E+−03 | 0.0000E+00 |
| S9 | −2.8231E+−01 | 8.2021E−02 | −1.2240E+−02 | 7.4760E−04 |
| S10 | 3.9751E−02 | −7.6394E+−03 | 8.5234E−04 | −4.1702E+−05 |

FIG. 14A shows an longitudinal aberration curve of the optical imaging lens of embodiment 7, which indicates the deviations of light of different wavelengths from a convergent focus point after passing through the lens. FIG. 14B shows an astigmatic curve of the optical imaging lens of embodiment 7, which indicates a tangential image surface curvature and a sagittal image surface curvature. FIG. 14C shows a distortion curve of the optical imaging lens of embodiment 7, which indicates distortion magnitude values corresponding to different image heights. FIG. 14D shows the lateral color curve of the optical imaging lens of embodiment 7, which indicates the deviation of different image heights on the imaging surface of light passing through the lens. It can be seen from FIG. 14A to FIG. 14D that, the optical imaging lens provided in embodiment 7 can achieve good imaging quality.

### Embodiment 8

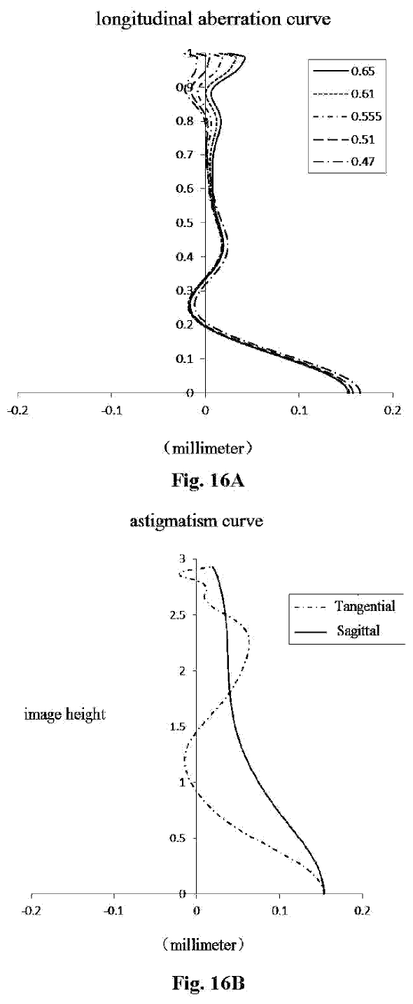

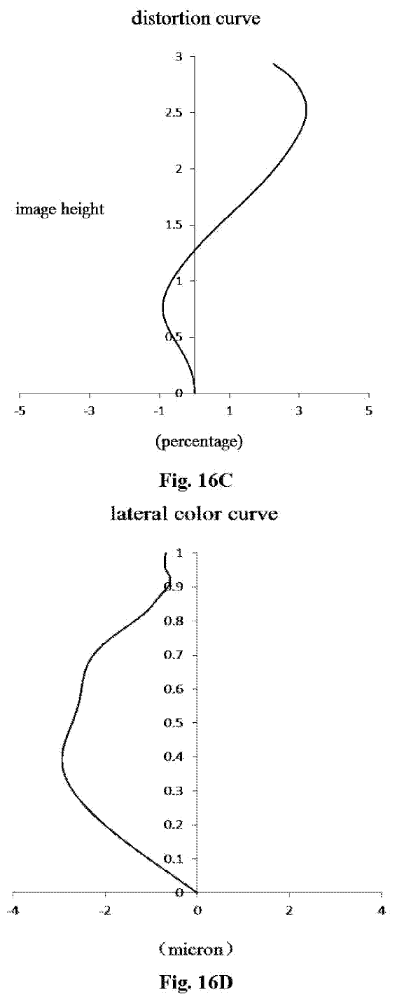

An optical imaging lens according to embodiment 8 of the disclosure is described below with reference to FIG. 15 to FIG. 16D. FIG. 15 shows a schematic structure view of an optical imaging lens according to embodiment 8 of the disclosure.

As shown in FIG. 15, the optical imaging lens comprises, in order from an object side to an image side along an optical axis: a first lens E1, a diaphragm STO, a second lens E2, a third lens E3, a fourth lens E4, a fifth lens E5, an optical filter E6 and an imaging surface S13.

The first lens E1 has a positive refractive power, an object-side surface S1 thereof is a convex surface, and an image-side surface S2 is a convex surface. The second lens E2 has a negative refractive power, an object-side surface S3 thereof is a convex surface, and an image-side surface S4 is a concave surface. The third lens E3 has a negative refractive power, an object-side surface S5 thereof is a concave surface, and an image-side surface S6 is a concave surface. The fourth lens E4 has a positive refractive power, an object-side surface S7 thereof is a concave surface, and an image-side surface S8 is a convex surface. The fifth lens E5 has a negative refractive power, an object-side surface S9 thereof is a concave surface, and an image-side surface S10 is a convex surface. The optical filter E6 has an object-side surface S11 and an image-side surface S12. Light from an object sequentially penetrates through each of the surfaces S1 to S2 and is finally imaged on the imaging surface 13.

Table 15 shows a basic parameter table of the optical imaging lens of embodiment 8, wherein, the units of curvature radius, thickness, and focal length are millimeters (mm). Table 16 shows higher order term coefficients that can be used for each aspherical mirror surfaces in embodiment 8, wherein each aspherical surface type can be defined by equation (1) given in embodiment 1 above.

TABLE 15
Embodiment 8: f = 6.82 mm, FOV = 47.6°, TTL = 5.50 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.4527 | 1.2474 | 1.50 | 81.6 | 2.61 | −0.0447 |
| | surface | | | | | | |
| S2 | Aspheric | −8.7087 | 0.1548 | | | | −8.6052 |
| | surface | | | | | | |
| STO | Sphere | Infinity | −0.0341 | | | | 0.0000 |
| S3 | Aspheric | 7.4235 | 0.3310 | 1.91 | 37.1 | −3.79 | 22.8938 |
| | surface | | | | | | |
| S4 | Aspheric | 2.2953 | 0.1332 | | | | −2.7392 |
| | surface | | | | | | |
| S5 | Aspheric | −14.7560 | 0.2500 | 1.65 | 23.5 | −10.04 | 0.0000 |
| | surface | | | | | | |
| S6 | Aspheric | 11.5595 | 1.5334 | | | | −43.5042 |
| | surface | | | | | | |
| S7 | Aspheric | −3.3001 | 0.4614 | 1.68 | 19.2 | 24.23 | −2.5429 |
| | surface | | | | | | |
| S8 | Aspheric | −2.9030 | 0.1449 | | | | −24.8332 |
| | surface | | | | | | |
| S9 | Aspheric | −2.6298 | 0.2200 | 1.55 | 56.1 | −5.97 | −3.0080 |
| | surface | | | | | | |
| S10 | Aspheric | −14.0470 | 0.0300 | | | | 20.4711 |
| | surface | | | | | | |
| S11 | Sphere | Infinity | 0.2100 | 1.52 | 64.2 | | |
| S12 | Sphere | Infinity | 0.8178 | | | | |
| S13 | Sphere | Infinity | | | | | |

TABLE 16

| Surface | | | | | |
|---|---|---|---|---|---|
| number | A4 | A6 | A8 | A10 | A12 |
| S1 | 8.4362E−03 | −5.2098E+−02 | 1.4483E−01 | −2.4668E+−01 | 2.6456E−01 |
| S2 | 6.9490E−02 | 1.6622E−03 | −3.6965E+−01 | 1.2280E+00 | −2.0716E++00 |
| S3 | −1.9849E+−02 | −2.5155E+−01 | 1.0868E+00 | −2.6004E++00 | 4.1978E+00 |
| S4 | −6.9126E+−02 | 1.1157E+00 | −1.1032E++01 | 6.8412E+01 | −2.5008E++02 |
| S5 | 2.9167E−01 | 1.9840E−01 | −3.1936E++00 | 2.0192E+01 | −6.9214E++01 |
| S6 | 1.8773E−01 | 2.9735E+00 | −3.3285E++01 | 2.1818E+02 | −8.9648E++02 |
| S7 | 4.5706E−02 | −1.7209E+−01 | 1.7596E−01 | −8.0462E+−02 | 4.5866E−03 |
| S8 | −4.7740E+−02 | −1.3657E+−01 | 1.5247E−01 | −6.4664E+−02 | 7.2132E−03 |
| S9 | −3.3621E+−01 | 3.1733E−01 | −4.5282E+−02 | −1.3238E+−01 | 1.1447E−01 |
| S10 | −4.1441E+−01 | 5.6840E−01 | −4.1657E+−01 | 1.8758E−01 | −5.5452E+−02 |

| Surface | | | | |
|---|---|---|---|---|
| number | A14 | A16 | A18 | A20 |
| S1 | −1.8119E+−01 | 7.6796E−02 | −1.8349E+−02 | 1.8602E−03 |
| S2 | 2.0418E+00 | −1.1871E++00 | 3.7802E−01 | −5.0894E+−02 |
| S3 | −4.5271E++00 | 3.1008E+00 | −1.2071E++00 | 2.0109E−01 |
| S4 | 5.6450E+02 | −7.7385E++02 | 5.9111E+02 | −1.9247E++02 |
| S5 | 1.4135E+02 | −1.7547E++02 | 1.2498E+02 | −3.9772E++01 |
| S6 | 2.3217E+03 | −3.6790E++03 | 3.2546E+03 | −1.2302E++03 |
| S7 | 6.5481E−03 | −1.0655E+−03 | −6.9354E+−05 | 0.0000E+00 |
| S8 | 1.5567E−03 | −1.3988E+−04 | −4.1419E+−05 | 0.0000E+00 |
| S9 | −4.3635E+−02 | 8.6679E−03 | −8.3228E+−04 | 2.6583E−05 |
| S10 | 1.1283E−02 | −1.6308E+−03 | 1.5928E−04 | −7.8554E+−06 |

FIG. 16A shows an longitudinal aberration curve of the optical imaging lens of embodiment 8, which indicates the deviations of light of different wavelengths from a convergent focus point after passing through the lens. FIG. 16B shows an astigmatic curve of the optical imaging lens of embodiment 8, which indicates a tangential image surface curvature and a sagittal image surface curvature. FIG. 16C shows a distortion curve of the optical imaging lens of embodiment 8, which indicates distortion magnitude values corresponding to different image heights. FIG. 16D shows the lateral color curve of the optical imaging lens of embodiment 8, which indicates the deviation of different image heights on the imaging surface of light passing through the lens. It can be seen from FIG. 16A to FIG. 16D that, the optical imaging lens provided in embodiment 8 can achieve good imaging quality.

### Embodiment 9

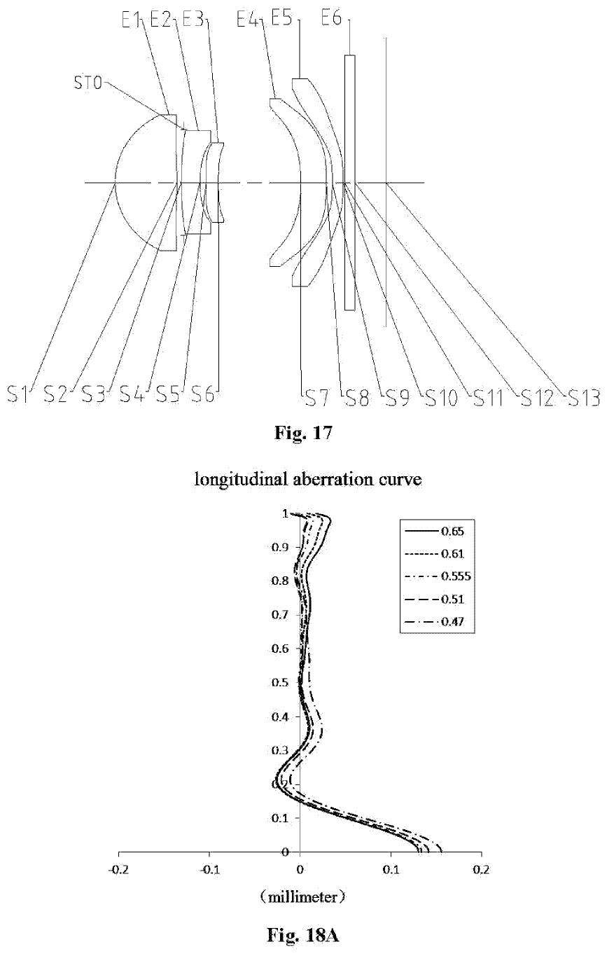

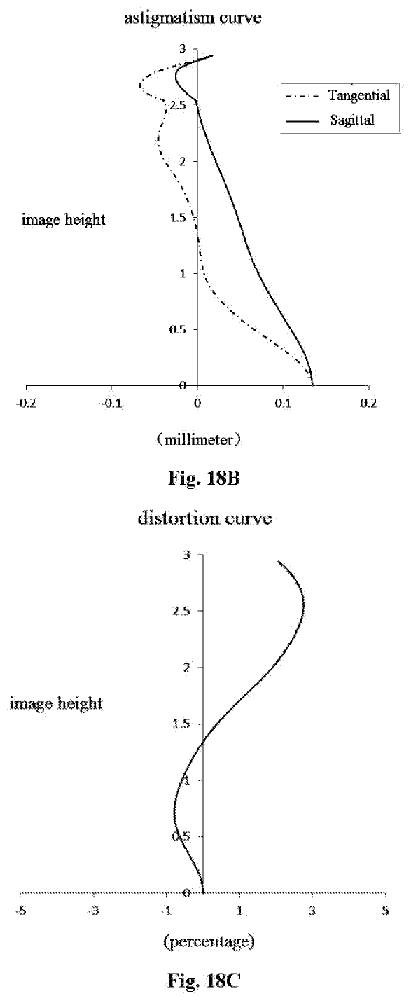

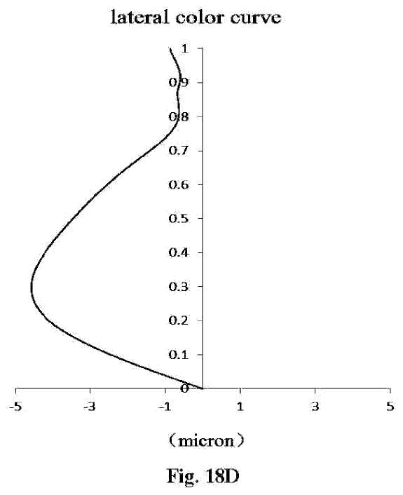

An optical imaging lens according to embodiment 9 of the disclosure is described below with reference to FIG. 17 to FIG. 18D. FIG. 17 shows a schematic structure view of an optical imaging lens according to embodiment 9 of the disclosure.

As shown in FIG. 17, the optical imaging lens comprises sequentially from an object side to an image side along an optical axis: a first lens E1, a diaphragm STO, a second lens E2, a third lens E3, a fourth lens E4, a fifth lens E5, an optical filter E6 and an imaging surface S13.

The first lens E1 has a positive refractive power, an object-side surface S1 thereof is a convex surface, and an image-side surface S2 is a convex surface. The second lens E2 has a negative refractive power, an object-side surface S3 thereof is a convex surface, and an image-side surface S4 is a concave surface. The third lens E3 has a negative refractive power, an object-side surface S5 thereof is a concave surface, and an image-side surface S6 is a concave surface. The fourth lens E4 has a negative refractive power, an object-side surface S7 thereof is a concave surface, and an image-side surface 8 is a convex surface. The fifth lens E5 has a positive refractive power, an object-side surface S9 thereof is a concave surface, and an image-side surface S10 is a convex surface. The optical filter E6 has an object-side surface S11 and an image-side surface S12. Light from an object sequentially penetrates through each of the surfaces S1 to S12 and is finally imaged on the imaging surface 313.

Table 17 shows basic parameters of the optical imaging lens of embodiment 9, wherein, the units of curvature radius, thickness, and focal length are millimeters (mm). Table 18 shows higher order term coefficients that can be used for each aspherical mirror surfaces in embodiment 9, wherein each aspherical surface type can be defined by equation (1) given in embodiment 1 above.

TABLE 17
Embodiment 9: f = 6.82 mm, FOV = 47.6°, TTL = 5.50 mm

| | | | | Materials | | | |
|---|---|---|---|---|---|---|---|
| Surface | Surface | Curvature | | Refractive | Abbe | Focal | Conic |
| number | type | radius | Thickness | index | number | length | coefficient |
| OBJ | Sphere | Infinity | Infinity | | | | |
| S1 | Aspheric | 1.4446 | 1.2550 | 1.49 | 70.4 | 2.57 | −0.0789 |
| | surface | | | | | | |
| S2 | Aspheric | −6.8152 | 0.1435 | | | | −31.8995 |
| | surface | | | | | | |
| STO | Sphere | Infinity | −0.0593 | | | | |
| S3 | Aspheric | 5.3732 | 0.3809 | 1.96 | 29.8 | −3.29 | 11.9269 |
| | surface | | | | | | |
| S4 | Aspheric | 1.9158 | 0.1250 | | | | −2.3022 |
| | surface | | | | | | |
| S5 | Aspheric | −40.6221 | 0.2500 | 1.65 | 23.5 | −14.29 | 0.0000 |
| | surface | | | | | | |
| S6 | Aspheric | 11.9113 | 1.6769 | | | | −37.7901 |
| | surface | | | | | | |
| S7 | Aspheric | −3.0756 | 0.5155 | 1.68 | 19.2 | −6.23 | 0.8242 |
| | surface | | | | | | |
| S8 | Aspheric | −12.0819 | 0.1206 | | | | 29.2373 |
| | surface | | | | | | |
| S9 | Aspheric | −14.8006 | 0.2200 | 1.55 | 56.1 | 60.00 | 36.1577 |
| | surface | | | | | | |
| S10 | Aspheric | −10.2478 | 0.0300 | | | | 1.8421 |
| | surface | | | | | | |
| S11 | Sphere | Infinity | 0.2100 | 1.52 | 64.2 | | |
| S12 | Sphere | Infinity | 0.6319 | | | | |
| S13 | Sphere | Infinity | | | | | |

TABLE 18

| Surface | | | | | |
|---|---|---|---|---|---|
| number | A4 | A6 | A8 | A10 | A12 |
| S1 | 8.4668E−03 | −4.9883E+−02 | 1.4291E−01 | −2.4735E+−01 | 2.6779E−01 |
| S2 | 6.8975E−02 | 3.3793E−02 | −4.4664E+−01 | 1.3177E+00 | −2.1293E++00 |
| S3 | −4.1830E+−02 | −1.2865E+−01 | 7.5340E−01 | −2.1322E++00 | 3.8243E+00 |
| S4 | −1.0354E+−01 | 1.2728E+00 | −1.1142E++01 | 6.7700E+01 | −2.4740E++02 |
| S5 | 2.5740E−01 | 3.5862E−01 | −3.1554E++00 | 1.9070E+01 | −6.5511E++01 |
| S6 | 1.7546E−01 | 2.9501E+00 | −3.2676E++01 | 2.1552E+02 | −8.9041E++02 |
| S7 | −8.6656E+−02 | 1.2977E−01 | −1.7957E+−01 | 1.4247E−01 | −6.8699E+−02 |
| S8 | −2.7533E+−01 | 1.9210E−01 | −9.9452E+−02 | 3.0275E−02 | −5.6971E+−03 |
| S9 | −5.5393E+−01 | 3.7967E−01 | 7.5358E−02 | −2.5869E+−01 | 1.6615E−01 |
| S10 | −3.8704E+−01 | 4.4001E−01 | −2.6461E+−01 | 1.0556E−01 | −3.2354E+−02 |

| Surface | | | | |
|---|---|---|---|---|
| number | A14 | A16 | A18 | A20 |
| S1 | −1.8356E+−01 | 7.7401E−02 | −1.8349E+−02 | 1 8602E−03 |
| S2 | 2.0616E+00 | −1.1900E++00 | 3.7802E−01 | −5.0894E+−02 |
| S3 | −4.3731E++00 | 3.0763E+00 | −1.2071E++00 | 2.0109E−01 |
| S4 | 5.6059E+02 | −7.7175E++02 | 5.9111E+02 | −1.9247E++02 |
| S5 | 1.3586E+02 | −1.7242E++02 | 1.2498E+02 | −3.9772E++01 |
| S6 | 2.3145E+03 | −3.6756E++03 | 3.2546E+03 | −1.2302E++03 |
| S7 | 1.8225E−02 | −1.7308E+−03 | −6.9354E+−05 | 0.0000E+00 |
| S8 | 2.9002E−04 | 2.3197E−04 | −4.1419E+−05 | 0.0000E+00 |
| S9 | −5.3627E+−02 | 9.4266E−03 | −8.3228E+−04 | 2.6583E−05 |
| S10 | 7.9599E−03 | −1.4368E+−03 | 1.5928E−04 | −7.8554E+−06 |

FIG. 18A shows an longitudinal aberration curve of the optical imaging lens of embodiment 9, which indicates the deviations of light of different wavelengths from a convergent focus point after passing through the lens. FIG. 18B shows an astigmatic curve of the optical imaging lens of embodiment 9, which indicates a tangential image surface curvature and a sagittal image surface curvature. FIG. 18C shows a distortion curve of the optical imaging lens of embodiment 9, which indicates distortion magnitude values corresponding to different image heights. FIG. 18D shows the lateral color curve of the optical imaging lens of embodiment 9, which indicates the deviation of different image heights on the imaging surface of light passing through the lens. It can be seen from FIG. 18A to FIG. 18D that, the optical imaging lens provided in embodiment 9 can achieve good imaging quality.

In summary, embodiments 1 to 9 meet the relationships shown in Table 19, respectively.

TABLE 19

| | Embodiment | | | | | | | | |
|---|---|---|---|---|---|---|---|---|---|
| Equation | 1 | 2 | 3 | 4 | 5 | 6 | 7 | 8 | 9 |
| TTL/f | 0.85 | 0.81 | 0.81 | 0.80 | 0.81 | 0.81 | 0.81 | 0.81 | 0.81 |
| V1 − V2 | 51.78 | 62.71 | 51.78 | 40.61 | 51.78 | 51.78 | 60.73 | 44.56 | 40.61 |
| V3 − V4 | 4.24 | 4.24 | 4.24 | 4.24 | 4.24 | 4.24 | 4.24 | 4.24 | 4.24 |
| T23/T12 | 0.98 | 0.11 | 0.40 | 0.90 | 0.74 | 0.40 | 0.19 | 1.10 | 1.48 |
| CT1/(CT4 + CT5) | 1.14 | 1.46 | 1.47 | 1.80 | 1.82 | 1.53 | 1.22 | 1.83 | 1.71 |
| F/CT1 | 4.87 | 5.85 | 5.49 | 5.43 | 4.93 | 5.64 | 5.85 | 5.47 | 5.43 |
| SAG41/CT4 | −1.04 | −0.96 | −1.17 | −1.04 | −1.36 | −1.42 | −1.16 | −1.07 | −1.22 |
| F/T34 | 4.84 | 5.06 | 3.98 | 4.54 | 4.12 | 3.71 | 4.96 | 4.45 | 4.06 |
| (R6 + R7)/(R6 − R7) | 0.21 | 0.25 | 0.28 | 0.38 | 0.07 | 0.04 | 0.35 | 0.56 | 0.59 |
| f/R3 + f/R4 | 3.85 | 4.41 | 4.45 | 4.31 | 3.49 | 3.46 | 5.23 | 3.89 | 4.83 |
| TTL/ImgH | 1.90 | 1.88 | 1.82 | 1.88 | 1.89 | 1.86 | 1.89 | 1.87 | 1.87 |
| f/f4 | −0.09 | 0.53 | −0.12 | 0.08 | −0.18 | 0.15 | 0.58 | 0.28 | −1.09 |
| f/R8 + f/R9 | −5.30 | −6.13 | −5.78 | −4.24 | −5.22 | −6.06 | −6.66 | −4.94 | −1.02 |

The disclosure also provides an imaging device, wherein the electronic photosensitive element can be a Charge Coupled Device (CCD) or a Complementary Metal Oxide Semiconductor (CMOS). The imaging device may be a stand-alone imaging device, such as a digital camera, or an imaging module integrated on a mobile electronic equipment, such as a cell phone. The imaging device is equipped with the optical imaging lens described above.

The above description is only description about the preferred embodiments of the disclosure and adopted technical principles. Those skilled in the art should know that the scope of present disclosure involved in the disclosure is not limited to the technical solutions formed by specifically combining the technical features and should also cover other technical solutions formed by freely combining the technical features or equivalent features thereof without departing from the inventive concept, for example, technical solutions formed by mutually replacing the features and (but not limited to) the technical features with similar functions disclosed in the disclosure.

What is claimed is:

1. An optical imaging lens, comprising sequentially from an object side to an image side along an optical axis: a first lens, a second lens, a third lens, a fourth lens and a fifth lens having refractive power, wherein,
the first lens has a positive refractive power, an object-side surface thereof is a convex surface;
the second lens has a negative refractive power;
TTL is a distance from the object-side surface of the first lens to an imaging surface of the optical imaging lens on the optical axis and a total effective focal length f of the optical imaging lens meet TTL/f<0.9; and
an abbe number V3 of the third lens and an abbe number V4 of the fourth lens meet 0<V3−V4<10.

2. The optical imaging lens as claimed in claim 1, wherein an abbe number V1 of the first lens and an abbe number V2 of the second lens meet 40≤V1−V2<65.

3. The optical imaging lens as claimed in claim 1, wherein a separation distance T12 of the first lens and the second lens on the optical axis and a separation distance T23 of the second lens and the third lens on the optical axis meet 0<T23/T12<1.5.

4. The optical imaging lens as claimed in claim 1, wherein a center thickness CT1 of the first lens, a center thickness CT4 of the fourth lens, and a center thickness CT5 of the fifth lens meet 1.0<CT1/(CT4+CT5)<2.0.

5. The optical imaging lens as claimed in claim 1, wherein the total effective focal length f of the optical imaging lens and a center thickness CT1 of the first lens meet 4.5<f/CT1<6.0.

6. The optical imaging lens as claimed in claim 1, wherein a vector height SAG41 of an object-side surface of the fourth lens and a center thickness CT4 of the fourth lens meet −1.5≤SAG41/CT4≤0.9.

7. The optical imaging lens as claimed in claim 1, wherein the total effective focal length f of the optical imaging lens and a separation distance T34 of the third lens and the fourth lens on the optical axis meet 3.5<f/T34<5.5.

8. The optical imaging lens as claimed in claim 1, wherein a curvature radius R6 of an image-side surface of the third lens and a curvature radius R7 of an object-side surface of the fourth lens meet 0≤(R6+R7)/(R6−R7)≤0.6.

9. The optical imaging lens as claimed in claim 1, wherein the total effective focal length f of the optical imaging lens, a curvature radius R3 of an object-side surface of the second lens, and a curvature radius R4 of an image-side surface of the second lens meet 3.0<f/R3+f/R4<5.5.

10. The optical imaging lens as claimed in claim 1, wherein the total effective focal length f of the optical imaging lens and an effective focal length f4 of the fourth lens meet −0.2≤f/f4≤0.6.

11. The optical imaging lens as claimed in claim 1, wherein the total effective focal length f of the optical imaging lens, a curvature radius R8 of an image-side surface of the fourth lens, and a curvature radius R9 of an object-side surface of the fifth lens meet −7.0<f/R8+f/R9<−4.0.

12. The optical imaging lens as claimed in any one of claims 1 to 11, wherein ImgH is a half the diagonal length of an effective pixel area on an imaging surface of the optical imaging lens, TTL is a distance from the object-side surface of the first lens to the imaging surface of the optical imaging lens on the optical axis, TTL and ImgH meet TTL/ImgH≤1.9.

13. The optical imaging lens as claimed in any one of claims 1 to 11, wherein the first lens and the second lens are both glass lenses.

14. An optical imaging lens, comprising sequentially from an object side to an image side along an optical axis: a first lens, a second lens, a third lens, a fourth lens and a fifth lens having refractive power, wherein,
the first lens has a positive refractive power, an object-side surface thereof is a convex surface;
the second lens has a negative refractive power;
TTL is a distance from an object-side surface of the first lens to an imaging surface of the optical imaging lens on the optical axis and a total effective focal length f of the optical imaging lens meet TTL/f<0.9; and
a center thickness CT1 of the first lens, a center thickness CT4 of the fourth lens and a center thickness CT5 of the fifth lens meet 1.0<CT1/(CT4+CT5)<2.0.

15. The optical imaging lens as claimed in claim 14, wherein an abbe number V1 of the first lens and an abbe number V2 of the second lens meet 40≤V1−V2<65.

16. The optical imaging lens as claimed in claim 15, wherein the first lens and the second lens are both glass lenses.

17. The optical imaging lens as claimed in claim 15, wherein an abbe number V3 of the third lens and an abbe number V4 of the fourth lens meet 0<V3−V4<10.

18. The optical imaging lens as claimed in claim 14, wherein the total effective focal length f of the optical imaging lens, a curvature radius R3 of an object-side surface of the second lens, and a curvature radius R4 of an image-side surface of the second lens meet 3.0<f/R3+f/R4<5.5.

19. The optical imaging lens as claimed in claim 14, wherein a curvature radius R6 of an image-side surface of the third lens and a curvature radius R7 of an object-side surface of the fourth lens meet 0≤(R6+R7)/(R6−R7)≤0.6.

20. The optical imaging lens as claimed in claim 14, wherein the total effective focal length f of the optical imaging lens, a curvature radius R8 of an image-side surface of the fourth lens, and a curvature radius R9 of an object-side surface of the fifth lens meet −7.0<f/R8+f/R9<−4.0.

21. (canceled)

22. (canceled)

23. (canceled)

24. (canceled)

25. (canceled)

26. (canceled)
